(19) United States
(12) Patent Application Publication
(10) Pub. No.: US 2014/0054856 A1
(43) Pub. Date: Feb. 27, 2014

(54) CARD HAVING A FLEXIBLE, DYNAMICALLY CHANGEABLE DISPLAY, A SET OF SUCH CARDS AND RELATED SYSTEM AND METHOD

(71) Applicant: Bally Gaming, Inc., Las Vegas, NV (US)

(72) Inventor: Stephen Patton, Reno, NV (US)

(73) Assignee: Bally Gaming, Inc., Las Vegas, NV (US)

(21) Appl. No.: 14/066,983

(22) Filed: Oct. 30, 2013

Related U.S. Application Data
(63) Continuation of application No. 13/276,868, filed on Oct. 19, 2011.

(51) Int. Cl. G07F 17/32; A63F 1/02

(52) U.S. Cl. CPC G07F 17/326; A63F 1/02
USPC 273/293

(57) ABSTRACT

A dynamically changeable, flexible card is set forth such as a playing card or a set of playing cards. The cards have one or more flexible displays controlled by a controller to change the display(s). The controller may interface with a wireless communication device to control the displays For card games, the electronic display can be changed so that only several such cards need be used to play the game. The face value content of the display can be changed by contact or wirelessly.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### CROSS-REFERENCE TO RELATED APPLICATION

This application is a continuation application of U.S. application Ser. No. 13/276,868 filed Oct. 19, 2011 and titled “A Card Having a Flexible, Dynamically Changeable Display, A Set of Such Cards and Related System and Method”.

### BACKGROUND OF THE INVENTION

1. Field of the Invention

These disclosed embodiments pertain generally to the use of small displays, including flexible displays, and miniaturized computer components to create dynamic playing cards, called Dynamic Playing Cards (DPC).

2. Description of the Related Art

Modern Card games have been a staple of game play, gambling in particular, as possibly as early as 1000 years ago in China. Over the centuries, several physical innovations have been incorporated to bring us the features of a standard deck of cards we have today, some of which include manufacturing materials and processes, rounded corners, suits and face values, and card value in the corners for easy viewing.

A typical playing card consists of a “face” side and “back” side. The face Side identifies the card and thus distinguishes each card from another. The backs of all the cards in a deck are identical so that the identity of the card can be concealed by anyone viewing the back of the card.

Typically the face value of a card is defined by a rank and a suit. Different cultures use different suits and ranks. For example, the Anglo-American-French playing deck usually consists of four suits Hearts, Diamonds, Spades, and Clubs and ranks 2-10 and Jack, Queen, King, and Ace. Many Central European cultures play with suits Hearts, Bells, Leaves, and Acorns and ranks VII, VIII, IX, X, Under, Over, King and Ace. The Swiss often play with a deck consisting of Roses, Bells, Acorns, and Shields and ranks 6 to 10, jacks, queens, kings and aces. As one can image, the possibilities for suits and ranks are limitless. The set of all unique playing cards is a deck of cards. In most cases each card is unique, but some decks of playing cards allow duplicate rank/suit pairs (e.g. game of Uno). Some games use multiple decks. In such games there are duplicate rank/suit pairs.

Playing cards have been used in a variety of venues. The most common are game playing (many of which incorporate a wagering component), magic tricks, fortune telling, board games, encryption, toy building components (e.g. house of cards), educational tools, and many other entertainment purposes.

Another auxiliary use of playing cards has been advertising or providing secondary entertainment value. Traditionally, this has been done by 1) utilizing the space on the backs of cards to advertise one or more products (e.g. branded cards), 2) having a customized face design for special cards or rank/suite pairs like the jokers or Ace of Spades that promote or highlight one or more the products, or 3) designing custom designs for each card which promotes or highlights one or more products (e.g. women, high value Iraqi targets, etc). Sports or other entertainment activities have also generated cards for collection which include on one side a picture of a Baseball player on one side and his statistics on the other.

Although there are a variety of techniques and materials used, the traditional playing card involves printing on a plastic, card board, or otherwise flexible material. As a result, the playing card, once printed, is static and forever defined. Moreover, the card has no intelligence and therefore cannot interact with the player, surrounding cards, or any other aspect of its environment.

Since all cards are included in a deck and also since the rank/suit of each card does not change; randomization of the sequence of cards is accomplished by shuffling the deck. Shuffling may be done manually by hand or through the use of a shuffling machine. Shuffling can consume more than an insignificant amount of time. There are numerous situations where this time is at best inconvenient (e.g. playing games at home) or at worst costly (e.g. casino where time spent shuffling could be used having the players wager). In cases where shuffling has been mechanically automated, there is a cost associated with the automated shuffling device.

Finally, in order to include all playing cards in a deck; the entire deck must be printed. For example, to include all 52 cards (e.g. from a standard Anglo-American-French deck) in a game (e.g. Poker), even though only a maximum of 19 cards (6 players×2 cards+5 common cards+2 burned cards) are ever in play. For games that employ more than one deck, the inefficiency is multiplied.

In prior art, tracking card play in a casino environment has been achieved by the use of cameras, bar code or other types of optical scanners, RFID tags combined with some recognizable printing or component on a physical card, such as an optically identifiable pattern or image that is indistinguishable to the naked eye (e.g. bar code) or RFID tag, or through optical character recognition read by cameras either below the table, in the table, over the table, or in the card shoe or chute that is read is the dealer pulls a card to deal. Except in games where card position is non-discretionary, knowing which cards a player has had been challenging.

A need arises to provide a dynamic, visually alterable, smart card that maintain as many of the physical features as possible of traditional cards that players enjoy.

A need arises for a general purpose playing card that can change the suit, rank, and/or number of cards in a deck based on which game or other purpose the deck is being used for.

A need arises to minimize the inefficient use of physical cards required for a game, requiring only a card for the maximum number of physical cards in play rather than physical card for every possible card face.

A need arises to not incur the hard or soft expense of shuffling cards.

A need arises to increase the auxiliary advertising or secondary entertainment on the back of cards by having the back be dynamic so that it cannot be used by a player to physically identify the face.

A need arises to have a physical card to be aware of and interact with its environment, including the player, other cards, or other participants in the game.

A need arises for a physical card to identify or authenticate the person holding the card.

A need arises to record which cards were dealt to, selected by, and/or played by a player. A need also arises to record which cards were handled by anyone, including a dealer, another player, or someone else.

### SUMMARY OF THE INVENTION

A dynamic Playing Card and the system and method of integrating it into a game, with or without wagering, are disclosed.

In accordance with one or more embodiments, a dynamic playing card (DPC) consists of two displays, back to back, representing a face and back, or a single display representing a face with a static back, shaped and sized and forming the appearance of a traditional physical playing card. The DPC includes, but is not limited to, a video display processor, a central logic processor, a power store, power receiver or generator, and a physical contact component for power store replenishment and/or communication, all miniaturized to fit into the dynamic playing card with the goal of not significantly modifying the look and feel of the DPC from that of a traditional playing card. The DPC is able to change the face value displayed, and possibly its back appearance, assuming a back display. Game play can remain the same or it can be streamlined by time saving modifications such as not having to physically shuffle the cards or even deal cards. The physical DPC's can be assigned to players and held continuously during the gaming session and the faces changed as needed. Moreover, the DPC can visually communicate to the player to provide game hints, help, advertisements, bonus games, or other entertainment or informational messages. Where the back of the card is dynamic, the DPC can display various, possibly unrelated, images and messages without compromising the integrity of the DPC, or give away its face value.

Other aspects of this invention may include one or more of the following: a touch detection layer (i.e. touch screen) on one or both sides of the playing card and a touch controller processor, a wireless communication component, a proximity component, gyroscope or other motion detector, or location detecting device, all miniaturized to fit into the dynamic playing card with the goal of not significantly modifying the look and feel of the DPC from that of a traditional playing card. Through the wireless or contact communication component(s), the DPC communicates with a central game control system and is aware of and can collaborate with nearby cards, for example, those also held or assigned to a certain player. Further embodiments disclose the DPC being aware of surrounding players as well. The touch detector can detect single or multiple touches on one or both sides of the cards, allowing a person to physically interact with the DPC and in some case the DPC to read one or more finger prints of the holder for the purpose of identification or authentication. The gyroscope can determine when the DPC is in motion, possibly using the motion to seed a random number generator. The location detection enables the DPC to know its location. Through the wireless communication component, the DPC may communicate location data, motion data, player data, player interactions, and/or computations based on the aforementioned data to the central system, other DPC's, or other devices.

Other features and numerous advantages of the various embodiments will become apparent from the following detailed description when viewed in conjunction with the corresponding drawings.

### BRIEF DESCRIPTION OF THE DRAWINGS

FIG. 1A is a diagram of an embodiment of a dynamic playing card.

FIG. 1B illustrates a cross section of a dynamic playing card (DPC).

FIG. 2 is a high-level diagram of the core electronic processing and logic components of a dynamic playing card.

FIGS. 3A and 3B are a side view and front prospective view of a card shoe modified to accommodate a deck of dynamic playing cards and communicate through the use of a metal contact place.

FIG. 4 is an exemplar depiction of front and back display graphics.

FIG. 5 is a diagram of an exemplary system architecture.

FIG. 6 is a diagram of DPC's coordinating to create a larger virtual display

FIG. 7 is a flowchart describing one embodiment of the process of a DPC Manager initiating management control of a DPC, transferring from an existing manager if necessary.

FIG. 8 is a diagram of several examples of DPC's providing helpful game related information.

FIG. 9 is a diagram of an example DPC's automatically sorting a player's hand

FIG. 10 is a logic diagram illustrating operation of a bonus feature.

### DETAILED DESCRIPTION

This invention incorporates a broad definition of a playing card and card game, as it is played with a deck of playing cards. Various embodiments are directed to traditional wagering card games, but to one skilled in the arts, it is easy to extrapolate these embodiments to other non-wagering card games.

The embodiments are illustrated and described herein, by way of example only, and not by way of limitation. Referring now to the drawings, there are shown illustrative examples of dynamic playing card or referred to hereafter as a DPC 10 for use in a casino or other wagering venue such as a keno, bingo, or poker parlor (including amusement for prizes).

Turning to the drawings there is shown a diagram of an embodiment of a two-sided dynamic player card (DPC) 10 according to the present invention. In it, the DPC 10 consists of two dynamic displays; the card face or front display 12, and the card back or back display 14 manufactured back-to-back so that the displays create each side of the DPC 10. In an alternative embodiment, the back display 14 is replaced with a static representation of the back of a playing card such as a printed velum, plastic, paper layer or the like.

In an alternative embodiment, the DPC 10 may have more than two displays arranged side by side at one or both of the front and back displays 12, 14, and/or back-to-back to create a flat playing card. In this case, the displays constructing the front display 12 of the DPC 10 can be considered as a single front display for the purpose of this disclosure and is within the scope of this invention. Likewise, the display(s) constructing the back display 14 of the DPC 10 can be considered as a single back display for the purpose of this disclosure and is within the scope of this invention. In another embodiment, the multiple displays are assembled to create a three dimensional object, such as, but not limited to, a cube or pyramid. As herein described the DPC may have more than two touch screens 16a, 16b associated with the front and/or back displays 12, 14 to accept a user's touch as input as is known in the art.

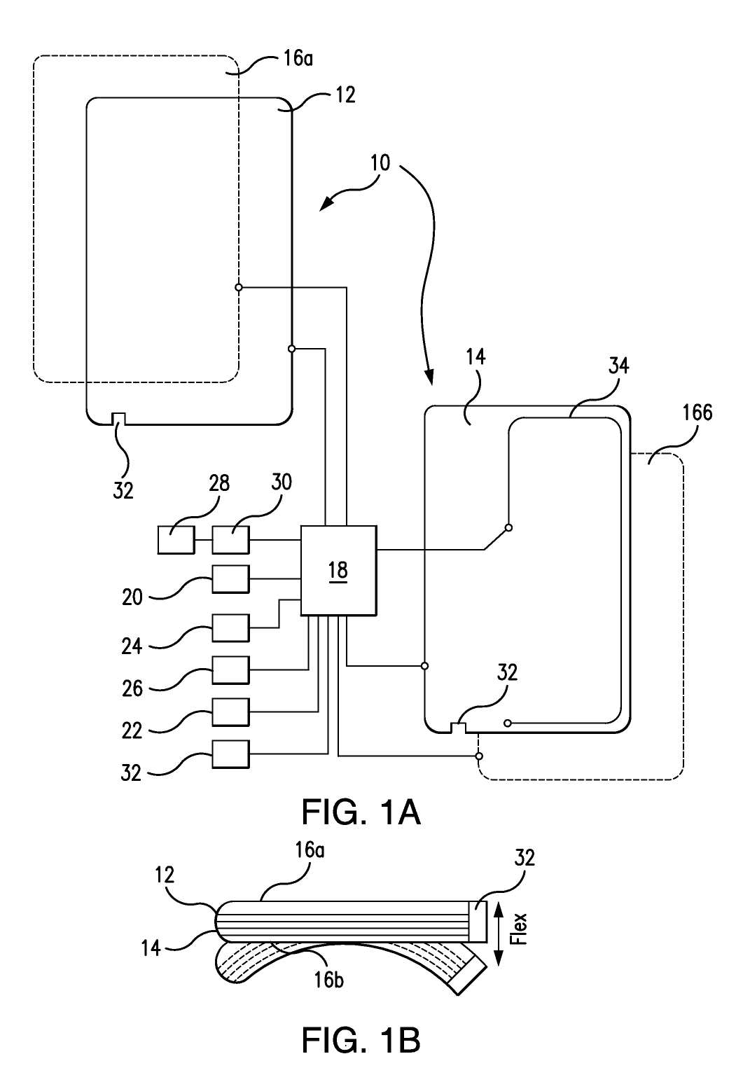

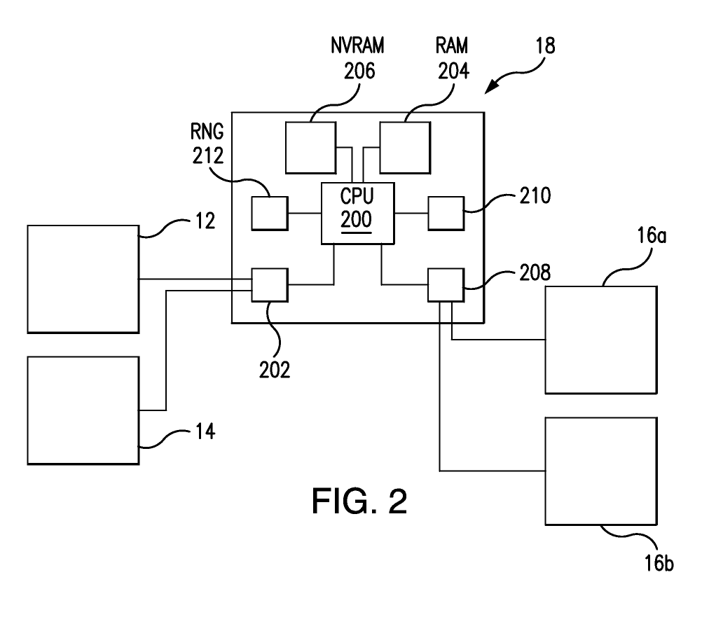

In the preferred embodiment and with reference to FIGS. 1 and 2, a core 18 defines the main electrical, processing, and logic components for the DPC 10. In one non-limiting example, the core 18 is a flexible printed circuit board. FIG. 2 is a high level schematic diagram that portrays the preferred embodiment where core 18 contains one or more main processors 200, one or more video controllers 202, random access memory 204, and non-volatile random access memory 206, all miniaturized to fit into the DPC 10 with the goal of not significantly modifying the look and feel of the DPC 10 from that of a traditional playing card.

In one embodiment, the DPC 10 is secured through a tamper detection device. In another embodiment, the tamper detection disables the DPC 10 when a physical security breach is detected.

### Processing and Core Platform

In one embodiment, the platform is a Picotux 100 or similar platform utilizing a 32-bit ARM 7 Netsilicon processor 200, modified to drive the front and back displays 12, 14, receive input from one or more touch screen microcontrollers 208, interfaced to a wireless module rather than an RJ45 connector, and mounted on a flexible printed circuit board (PCB). It has 2 MB of flash, non-volatile RAM 206. In an alternative embodiment, the platform is built around the PIC32MX family of microcontrollers from Microchip. One skilled in the art will easily recognize the actual processor selection is arbitrary and the incorporation of any other processor, including multi-core processors, for controlling a DPC 10 is within the scope of this invention.

In the preferred embodiment, the central processing unit 200 reads a program out of RAM 204 and/or NV RAM 206. In one embodiment, the program consists of processor-ready instructions and the processor 200 is able to execute them asis. In another embodiment, the processor 200 must compile or translate the instructions into processor-ready instructions before executing them. A non-limiting example is a Java program that the processor 200 must compile or translate into processor-ready instructions. In one embodiment, there are multiple programs running simultaneously on a single DPC 10. The programs that are primary executors of higher level DPC 10 behavior, display, and communication logic can be called applications.

In the preferred embodiment, there is a program, called an Operating System that instructs the processor 200 on how to access RAM 204 and other connected components. Part of its responsibility is to read the applications and manage their execution. This is similar to other computer system operating systems, such as the Microsoft Windows family of OS's, Apple's OSX, the Linux flavors, QNX, etc. These are hereby incorporated as non-limiting examples of possible operating systems implemented on a DPC 10. In another non-limiting embodiment, the operating system is the TinyOS developed at UC Berkley for use in devices that are severely resource constrained.

In one embodiment, the program code, including but not limited to operating system and application programs, is stored in nonvolatile RAM 206. In an alternative embodiment, the programs are stored on a read only medium (not shown). In yet another embodiment, the programs are stored outside the DPC 10 and are loaded through one or more communication mediums existing in the DPC 10. In an alternative embodiment, different programs or portions of the same program are stored and loaded from a plurality of sources.

In one embodiment, the program and or data are secured. In one non-limiting embodiment, the program and/or data are secured through the use of a signature. A signature is calculated for the program or data file and stored either with the file or separately somewhere else accessible to the processor. When the processor 200 loads the program it calculates the signature and compares it to the previously calculated signature. Non-limiting examples of signature algorithms are Secure Hash Algorithm family of algorithms (e.g. SHA-1, SHA-2, etc) and Message Digest algorithms (e.g. MD5).

In the preferred embodiment, the front and back displays 12, 14 are connected to the core 18 housing the processor 200 and a video controller 202. In one embodiment, in the core 18, the processor 200 sends instructions and data to the video controller 202, which in turn sends video signals to be displayed as graphic images on the front 12 and/or back 14 displays. The content of the video signal, or the execution of its instructions, results in displaying either a static image or a variable image such as an animation or video clip. In another embodiment, the variable image may be displaying an image that is perceived to be static. In an alternative embodiment, the core 18 sends the definition of a static image to be maintained by one of the displays 12, 14 until instructed to change. Non-limiting examples of Video formats and containers include: MJPEG, Motion JPEG 2000, MPEG-1, MPEG-2, MPEG-4 ASP, MPEG-4/AVC, H.120, H.261, H.262, H.263, H.264, AMV, AVS, Dirac, Indeo, Pixlet, RealVideo, RTVideo, SheerVideo, Smacker, Snow, Theora, VC-1, VP6, VP7, WMV, 3GP, ASF, AVI, Bink, DMF, DPX, FLV, Matroska, MP4, MXF, NUT, Ogg, Ogg Media, QuickTime MOV, RealMedia, Smacker, RIFF, VOB, AIFF, AU, WAV, Shockwave SWA. Non-limiting examples of Image formats include: JPEG, JPEG 2000, lossless JPEG, JBIG, JBIG2, PNG, WBMP, BMP, GIF, ICER, ILBM, PCX, PGF, TGA, TIFF, JPEG XR/HD Photo.

In one embodiment, the DPC 10 includes miniaturized on-board speakers (not shown). In another embodiment, the DPC 10 communicates to external speakers through a wireless connection such as BlueTooth. In one embodiment, the processor 200 and/or video controller 202 synchronizes the video and animation with audio communicated to internal and/or external speakers. External speakers include, but are not limited to, physically connected headsets, wireless headsets, wireless speakers, directed sound speakers, or a cell phone or other communication device with a speaker.

Referring back to FIG. 1, in the preferred embodiment, the DPC 10 is flexible to some degree. This requires the front display 12 (and back display 14 if provided) to be flexible. In other embodiments, the DPC 10 has one or more of the following: back display 14, front touch screen 16a, back touch screen 16b. In this case, these components must also support some degree of flexibility. Similarly the core 18 and other components are either flexible, small enough to not impede the desired degree of flexibility or both. Likewise, in related embodiment, the displays, touch screens 16a, b, and other components are secured together essentially forming layers. In these embodiments, the layers are constructed in such a way that each layer flexes without separating or splitting from the adjoining components or layers. In an alternative embodiment, the DPC 10 is not flexible and is not intended to be bent or flexed. In yet another embodiment, portions of the DPC 10 support flexibility. In a non-limiting example, the corners of the DPC 10 are flexible allowing the player to bend the corner of the DPC 10 up slightly while the front face 12 is face down such that the turned-up corner reveals the face value of the DPC 10 similarly to how players often look at traditional playing cards.

### Front/Back Displays

In the preferred embodiment, the front and back displays 12, 14 are from the class of electrophoretic flexible displays. In one non-limiting embodiment, the front and back displays 12, 14 are manufactured using electrophoretic imaging film, where the display is constructed from microcapsules of tiny particles, colored black or white. To produce an image, the particles are positively or negatively charged to get the correct balance of grey tone to the top microcapsule where they are visible and remaining particles to the bottom of the microcapsule where they are hidden. In effect, each of these microcapsules is equivalent to a pixel on a standard LED, LCD style display. Two key benefits of this type of display are that it does not require a back light and once the particles have been charged, no additional power is required to maintain the image. Moreover, it is advantageous that the display is not backlit in that it maintains a look and feel similar to a traditional playing card. In one non-limiting embodiment, the front and/or back displays 12, 14 are flexible displays from E-Ink Corp, 733 Concord Ave., Cambridge, Mass. 02138. Another non-limiting example is the rollable display by Polymer Vision (Kastanjelaan 1000, Building SFH, 5616 LZ Eindhoven, The Netherlands) used in its Readius® reader product In one embodiment, the displays are active matrix. In an alternative the displays are passive matrix.

In an alternative embodiment, the front and/or back displays 12, 14 are from the class of electrochromic, color, flexible displays such as the Siemens (Siemens Corporation, 300 New Jersey Ave., Suite 1000, Washington, D.C. 20001) thin printable display. This type of display is controlled by a printed circuit and can be powered by a very thin printable battery or a photovoltaic cell. The goal is to be able to create the entire device—the display and its power source—using the same printing method.”

In another non-limiting example of a flexible display, the displays are flexible electroluminescent displays. In one non-limiting example, Sony Corporation (7-1, Konan, 1-Chome, Minato-Ku, Tokyo, Japan 108-0075) manufactures an Organic Light Emitting Diode (OLED) on an organic thin-film transistor (TFT) on a plastic substrate rather than glass creating a thin, lightweight and flexible full-color display.

In certain embodiments of the flexible display (e.g. electronphoretic, electrochromic, and electroluminescent), the substrate materials used to construct the flexible displays are plastic. In an alternative embodiment, the substrate is stainless steel.

In an alternative embodiment, the front and/or back displays 12, 14 are not flexible, but rather use traditional rigid display technology. Non-limiting examples are thin LCD and LED displays.

The use of any thin display technology for the front and/or back displays 12, 14 of a DPC 10 is within the scope of this invention. Also, as technology advances and flexible displays become higher quality, less power demanding, and fuller featured (such as 3D and holograms), assembling these into a DPC 10 is within the scope of this invention.

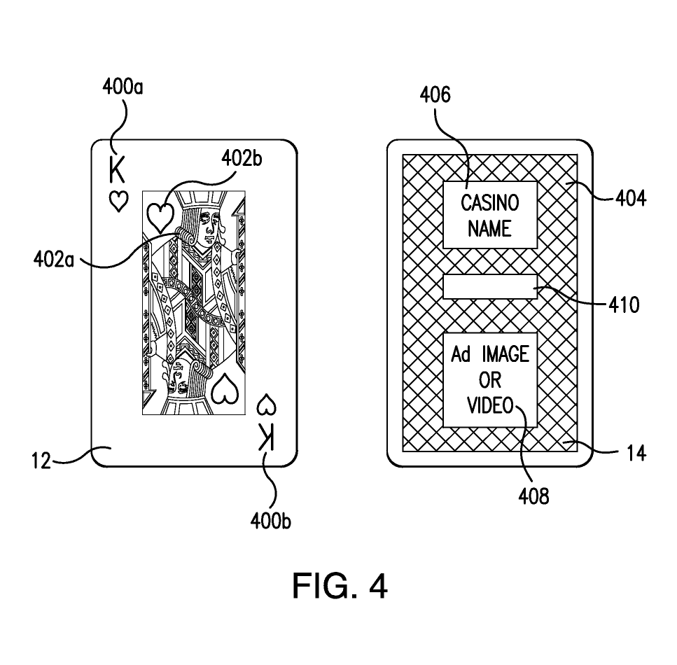

In the preferred embodiment, the front display 12 primarily displays the image of a traditional playing card which includes its suit and rank. In one embodiment, similar to prior art paper-based playing cards, the front display 12 shows the DPC's 10 rank and suit in diagonally opposite corners (upper left and lower right) as well as in the middle. FIG. 4 depicts a representative DPC 10 front display 12, as well as a back display 14. In FIG. 2, a King of Hearts is being displayed. In this example, two opposite corners 400a, b display the rank of the DPC 10. In the center of the front display 12 is displayed a graphic 402a, b showing the rank and suit. In one non-limiting example the top left corner 400a displays the rank right side up and the lower right corner 400b upside side, similar to a traditional playing card.

In a non-limiting embodiment, the back display 14 primarily presents a design or image common to all DPC 10 in a deck. Non-limiting examples of this common image is an interesting pattern or graphic 404, a branded image (e.g. branded for the casino) 406, an advertisement 408, or some combination thereof. In another embodiment, the back display 14 presents a common variable image such as an animation or video clip. In yet another embodiment, the back display 14 shows a combination of common static or variable images.

In a usual configuration the back display 14 of a DPC 10 shows the same graphic for all cards to prevent players from determining the value of the DPC 10 from the image of the back display 14. It would be advantageous to have different graphics on the backs of individual cards without inappropriately compromising the face value. In the preferred embodiment of the DPC 10, the back display 14 presents a design or image, or alternatively a variable image such as an animation or video clip, or a combination of static and variable images that are not the same for each DPC 10 in a deck. The possible back images are assigned to the DPC's 10 so that a person does not have an increased chance of knowing the face value of the DPC. In one embodiment, the face value of the DPC 10 is displayed or communicated through symbols or otherwise encoded in the static or variable images 410 on the back display 14 so that the face value can be determined with the aid of a machine such as an optical reader located outside the DPC 10. However, the encoding is a machine readable set of symbols 410 (e.g. bar code, glyph or other design) that may not be readable, understandable, recognizable, noticeable, distinguishable by, or possibly even visible to the human eye or some combination thereof of said characteristics. Symbols 410 may be a sequence of symbols displayed continuously or only at certain times, in subsets (like an animation) or in its entirety. If the face value is displayed in such a way as to be recognizable by a human, then that display is considered, by definition, to be a card face, not the back. Therefore, in one embodiment, it is possible for a DPC 10 to have two face displays 12 and no back display 14. In another embodiment, it is possible for a DPC 10 to have two face displays 12 at one time, and a front and back display 12, 14 at other times. In yet another embodiment, the definition of a DPC display may change so that the front display 12 becomes the back display 14 and the back display 14 becomes the front display 12.

In the prior art, multiple decks may be combined together, some of which may have different images at the back displays 14. This same concept can apply to multiple decks of DPC's 10. A deck can be defined as any arbitrary subset of DPC's 10, including a single DPC 10, and that a deck can be considered a virtual, dynamic subset of DPC's 10, rather than an constant physical subset. In one embodiment, a DPC 10 is assigned to one or more decks. In a non-limiting example, there are a set of n physical DPCs 10 {c1, . . . , cn}. There are two Decks {A,B}. A given card cx may an element of A, B, both A and B, or neither, and this may change over time. Likewise, just because cx and cy are elements of A, it does not follow that cx and cy are elements of B. Using this example, in one embodiment, back images may be assigned based on membership in a particular deck. In the prior art case of multiple decks, after certain cards have been revealed, it is possible that a person can have a higher probability of guessing what a given card is or is not compared with another card. For example, if there are two decks, one is blue and one is red, if the Ace of Hearts, Ace of Diamond, Ace of Spades, and Ace of Clubs from the blue deck is revealed, then when the player is looking at a blue deck card face down, he can know that the odds of the face value of that card being an ace is zero. Whereas, if that card were a red card, then the odds would be 1 in 13. In the preferred embodiment of a deck or multiple decks of a DPC 10, a person cannot increase his odds of guessing cards by knowing of which deck a physical card is a member combined with knowing which cards of certain decks have been revealed. In an alternative embodiment, the aforementioned nature of the changing odds of the physical deck is preserved.

### Touch Detection

Referring back to FIG. 1, in another embodiment, one or more of the front and/or back displays 12, 14 have the thin touch screens 16a,b that detect a person's touch and preferably the location of the touch. In the preferred embodiment, the touch screens 16a, b can detect multiple simultaneous touches. In an alternative embodiment, the touch screens 16a, b can only detect one touch at a time. Non-limiting examples of touch screen technologies include: Resistive, Surface acoustic wave, Capacitive, Infrared, Strain gauge, Optical imaging, Dispersive signal technology, Acoustic pulse recognition, Frustrated total internal reflection, and Diffused laser imaging.

In one embodiment, referring to FIG. 2, the core 18 also contains one or more touch screen microcontrollers 208. The touch screens 16a, b are connected to one or more touch controllers 208. The touch controllers 208 communicate touch data to the main processor 200.

In one embodiment, the touch data is associated to a virtual object displayed under or in the proximity of the touch location. Actions are attributed to the touch. Non-limiting examples are pressing a button, or selecting an object or item. In another embodiment, the touch screen 16a, b tracks a touch and drag and associates an action on a virtual object with the touch and drag. One non-limiting example is touching an icon on the front display 12 and moving the icon to a new location by sliding the finger (i.e. dragging) to the new location and lifting the finger to signify the end. In this example, the DPC 10 continually re-draws the icon to coincide with the finger's new position during the drag to provide the person the necessary visual feedback of the action.

In another embodiment, the touch data is not associated with any displayed object, but rather used to track if and how the DPC 10 is being held. In another embodiment, the touch data is able to detect if and how the DPC 10 is being covered. In one non-limiting example the DPC 10 is face up, but not displaying the face value of the card. The player places his hand curved over the front display 12 and the touch screen 16a detects how the player is covering the DPC 10 and the DPC 10 determines that the player is sufficiently covering the card to conceal the front display 12 from the view of other players. As a result, the DPC 10 displays the face value on the front display 12. In another embodiment, the DPC 10 displays only a portion of the face value based on which part of the front display 12 is sufficiently concealed from view by other players.

In another embodiment, the DPC 10 is face down and the player touches the back display 14 causing the DPC 10 to “turn over” and reveal the face value by switching which displays are the front and back displays 12, 14. The display showing then shows the graphics and images assigned to the face value of the DPC 10. In an alternative embodiment, the DPC 10 consists of a single display, in which case it has been displaying a back of a card and upon touching displays the face. In yet another alternative embodiment, the player touches the DPC 10 to turn it back over so that the content of the back display 14 is showing. This is referred to at Tap Turn Over or Tap Reveal.

In another embodiment, the touch screen 16a is a touch screen scanner and is able to scan an object touching the DPC 10. In one embodiment, the touch screen scanner scans the person's finger print. In another embodiment, the DPC 10 is able to distinguish between a finger touching the screen and some other object. Non-limiting examples include: the table, another DPC 10, chips, or other game pieces. In another embodiment, the one or more front and back displays 12, 14 are interlaced or interwoven with tiny cameras (not shown) and are able to track a player's fingers on the screen. In yet another embodiment, the tiny cameras have a viewing distance of a few feet in front of the DPC 10 and are able to view objects near the DPC 10. A single image is created from a composite of the images from all of the cameras. In one non-limiting embodiment, the DPC 10 is able to create an image of the face of the person in front of the cards for the purpose of facial recognition.

### Environmental Awareness

Referring back to FIG. 1, in an embodiment, the DPC 10 contains one or more components that detect the physical orientation, direction, motion, and/or location of the DPC 10 and is aware of its physical orientation, direction pointing, current motion, and/or absolute location or its location relative to some other object, and any changes in such.

In one embodiment, the DPC 10 contains a physical orientation monitor 20. In another non-limiting embodiment, the physical orientation monitor 20 is a tiny gyroscope which provides the DPC 10 vertical orientation. In one embodiment, the gyroscope provides angular data such that 0° means the DPC 10 is completely vertically upright, 90° means the DPC 10 is lying completely flat with the face up, 180° means the card is completely vertically upside down, and 270° means the card is lying completely flat face down, and other measurements provide different orientations proportionally between these extremes.

In one embodiment, the DPC 10 contains a direction detector 22. In another non-limiting embodiment, the direction detector 22 is a tiny compass that reports angular direction such that 0° means the DPC 10 is oriented with a basis side facing North, 90° means the DPC 10 is oriented East, 180° means the card is oriented South, and 270° means the card is oriented West, and other measurements provide different orientations proportionally between.

In one embodiment, the DPC 10 contains a location detector 24. In another non-limiting embodiment, the location detection component 24 is a global positioning system (GPS) chip which provides the DPC 10 its physical location. One non-limiting example of a miniaturized GPS chip is SE4110S global positioning system receiver such as a GNSS (Global Navigation Satellite System) receiver), which measures 2.2 mm square and 0.4 mm thick.

In the preferred embodiment, the DPC 10 is aware of its physical orientation and displays its static or variable images, or a portion of its images, so that they are properly aligned with the orientation of the DPC 10. A non-limiting example of the image is the middle rank and suit symbols. The result is that no matter which way a person holds a card, the middle rank and suit and displayed for ease of reading. In an alternative embodiment, the DPC 10 is aware of its directional orientation (e.g. North, South, East, or West) and can adjust its images or portion of its images appropriately. A non-limiting example is that the DPC 10 is aware of its directional orientation in relation to a player's view and adjusts the displays of its middle rank and suit graphic 402a, b for ease of reading by the player.

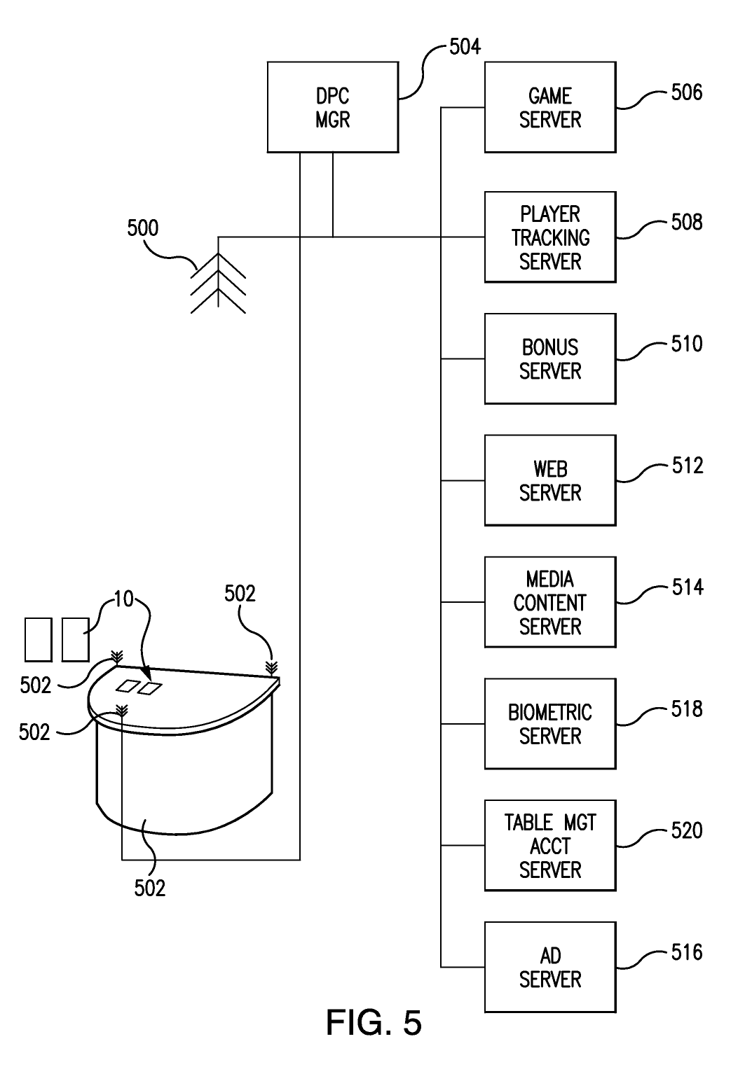

In one embodiment, the DPC 10 contains a motion detector 26. In another non-limiting embodiment, the motion detector 26 is an accelerometer which is able to detect motion, speed or velocity, and/or acceleration of the DPC 10. In an alternative embodiment, the wireless component 210 is able to calculate position and motion. In one non-limiting example, the wireless is able to triangulate its position relative to one or more transmitters or wireless access points 500 (FIG. 5) and from this determine its absolute or relative location and interpret change is location as motion, including velocity or speed and acceleration.

In an alternative embodiment, a single component performs a plurality of functions such as detect the physical orientation, direction, motion, and/or location. In another embodiment, there is a plurality of these multi-function components that in aggregate accomplish a subset of the aforementioned functions.

### Power and Battery

In one embodiment, the DPC 10 has a plurality of power sources 28 that supply the power needed to drive the front display 12, back display 14, and all other components on the DPC 10. Non-limiting examples of power consumers include core electrical and logic components 18, location detection 24, direction and physical orientation component(s) 20, touch screen 16a, b, or one or more batteries 30 that temporarily store the power for later use by one of the other power consumers.

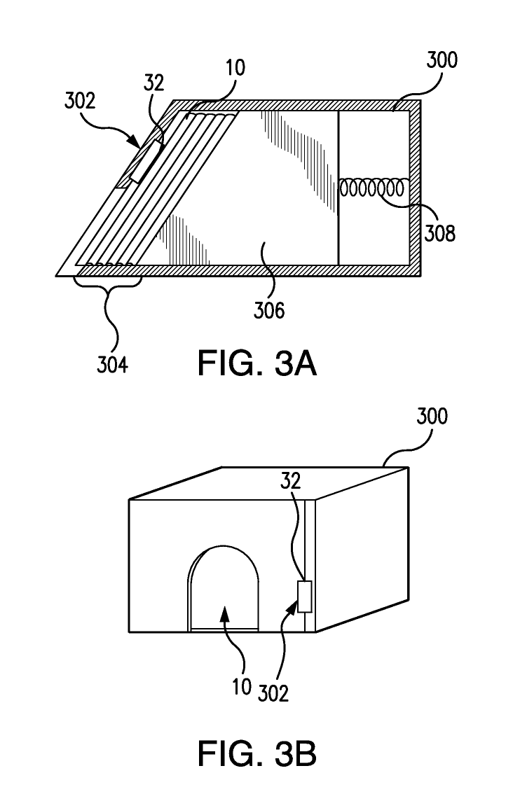

In one embodiment, the power source 28 is a receiver of wireless power. In a non-limiting embodiment, the wireless receiver power source 28 is a miniaturized magnetic resonant coupling coil. In one non-limiting embodiment, a master resonant coil is positioned in a defined area. Non-limiting examples include one side of a card shoe 300 (FIG. 3) or other storage device for the DPC 10, the perimeter of a defined area that the DPC 10 is expected to remaining such as a Blackjack table 502 (FIG. 5). Another miniaturized coil tuned to the same frequency is the DPC 10 power source 28. When power is applied to the master coil, it creates a magnetic field. The power source 28 resonates with the magnetic field generating an electric current. In an alternative embodiment, there is a plurality of master coils strategically placed around a defined area, such as a casino gaming floor, and powers multiple DPC's 10. This approach to wirelessly providing power is described in Technology Review (Published by MIT), March/April 2008 issue found at: http://www.technologyreview.com/read article.aspx?ch=specialsections&sc=emerging08&id=2 0248.

In another embodiment, the power source 28 is a miniaturized, thin voltaic cell which converts light energy into electrical current. In one embodiment, photovoltaic cell is a silicon wafer. In another embodiment, the photovoltaic device employs a thin, flexible, and possibly transparent substrate, possibly printed on a flexible polymer film.

In one embodiment, the power source 28 is a device that converts mechanical energy into electrical current. In one non-limiting example, the power source 28 includes miniaturized coil around a sliding magnet so that movement causes the magnet to pass through the coil to cause variation of a magnetic field of the coil, so that the coil produces an electric current by variation of the magnetic field, thereby generating the electricity so as to supply an electric power.

In an alternative embodiment, the power source is a receiver of electrical power through a physical connection. In one non-liming example, a physical metal contact 32 receives an electrical charge from a corresponding contact external to the DPC 10.

Other non-limiting embodiments of the power source 28 include: electrical currents going through a person's skin, thermoelectric materials which use miniature, thin-film technologies to convert thermal energy into electrical power, possibly sourced by the thermal energy generated by a person's body as he touches the DPC 10. One skilled in the arts will recognize that the miniaturized power source 28 may include a plurality of the solutions described by the aforementioned embodiments and examples but is not limited by those embodiment and examples.

In an embodiment, the power source 28 charges or recharges the battery 30 which then supplies the needed power for the components. In another embodiment, the battery 30 is actually a capacitor and the power source 28 charges the capacitor. In another embodiment, there is a plurality of power sources 28 and/or batteries/capacitors 30 receiving its power from any or all of the power sources 28. In yet another embodiment, one or more of the individual power consumers on the DPC 10 has its own power source 28, battery 30, or both. In an alternative embodiment, the batteries 30 are not charged by a power source, but directly from an external power source (not shown). In yet another embodiment, one or more batteries 30 are physically replaced in lieu of being recharged.

In one embodiment, the battery 30 is one or more thin film batteries (TFB). One non-limiting example of a thin film batteries are LiTE*STAR thin-film batteries. They are thin electrochemical batteries where the cathode and anode are separated by an electrolyte and are capable of being 0.5 mm thick and can be integrated onto a flexible PCB.

In another embodiment, the battery 30 is one or more nano-wire batteries, where the TFB cathode is made of nano-wires, thus increasing the surface area of the cathode and increasing the capacity for a given size. One non-limiting example is the nano-wire battery as provided by Enable IPC (4005 Felland Road, Suite 107, Madison, Wis. 53718)

In another embodiment, the battery 30 is a thin, flexible, printed battery, printed on a flexible plastic substrate. One non-limiting example is the battery used to power Power Paper by Power Paper, Inc (3 Ha'amal Street, West Industrial ZoneBelt Shemesh, 99102, Israel) which can be about 0.5 mm to 0.7 mm thick.

Other non-limiting embodiments of the battery 30 include: the use of carbon-micro-electro-mechanical (C-MEM) as the basis for fabrication of smart switchable array of batteries, or the use of electrode elements comprising flexible sheets of polymeric composition in which are dispersed finely-divided particulate materials capable of reversibly intercalating lithium ions during battery charge/discharge cycles to create polymeric laminated battery. One skilled in the arts will recognize that the miniaturized battery 30 may include a plurality of the solutions described preceding non-limiting embodiments and examples.

In one embodiment, the DPC 10 implements a plurality of power saving or power reduction strategies. Non-limiting examples include the use of electrophoretic flexible displays, such as that produce by eInk, whereby power is only used to change the display and no power is required to maintain an image on the display, and the use of IC and chips that employ intelligent sleep, suspend, or low power modes to lower power requirements in the other components that make up the DPC 10.

### Random Number Generator

Referring again to FIG. 2, in another embodiment, the DPC 10 has a random number generator 212. In one embodiment, the RNG 212 produces a pseudorandom sequence of numbers and uses a plurality of environmental inputs to seed its algorithm. In another embodiment, the RNG 212 is truly random and uses a plurality of environmental inputs to calculate its random number. In one non-limiting example, the RNG 212 uses certain data or output from the motion detector 26 as its input. In another embodiment, the RNG 212 uses touch data from one or more touch screens 16a, b or their associated touch microcontrollers 208 as its input. In another embodiment, the RNG 212 uses random noise or signal data from the wireless communication component 210 as input. In yet another embodiment, the RNG 212 uses some combination or alternation of a plurality of sources as its input. One skilled in the art will easily understand that any data from any onboard component, or any component external to the DPC 10 but communicated wirelessly, can be used as input to the RNG 212 and is included in the scope of this invention. In an alternative embodiment, seeds numbers and/or input data is stored in RAM 204. In another embodiment, the seed numbers and/or input data is stored in NV RAM 206. In yet another embodiment, the seed number and/or data used by the RNG 212 is constructed from a combination of one or more environmental inputs, such as those listed above, data stored in RAM 204, or NV RAM 206, or some combination thereof.

### Communication

Referring back to FIG. 2 in an embodiment, the core 18 contains one or more wireless components 208. In one embodiment, the wireless component is a Wi-Fi communication chip which communicates to a plurality of wireless access points 500 (FIG. 5). In another embodiment, the wireless component is a Bluetooth chip. One non-limiting example is the Memory Spot chip from Hewlett-Packard is 2 mm square and capable of 10 megabits per second communication with a built in antenna. Another non-limiting example, the wireless component is similar to the highly miniaturized wireless MEMS (micro-electro-mechanical system) foldable transceiver designed at the University of Florida that uses WLAN technology (described in TechID 04A026 at http://www.research.usfedu/pl/04A026.pdf). Other non-limiting examples are miniature Wi-Fi and Bluetooth chips from QualcommAtheros (1700 technology Drive, San Jose, Calif. 95110) which measure 32 square mm and 9.2 square mm respectively.

In another embodiment, the wireless component is an RFID tag. In one embodiment, the RFID chip communicates data to a nearby RFID reader. In another embodiment, the RFID chip is not connected to or communicated directly with or indirectly through other components physically located on the DPC to the main processor 200. One non-limiting example of a miniaturized RFID chip is Hitachi's RFID chip, dubbed Powder or Dust which measures 0.15 square mm in size and 7.5 micrometers thick.

In another embodiment, one or more nano-radios are used to receive, transmit, or both, data wirelessly. In yet another embodiment, the DPC 10 incorporates a plurality of communication components, chips, protocols, and/or methods.

In one embodiment, the wireless component uses one or more specific frequencies. In an alternative embodiment, the wireless component implements Frequency Hopping spread spectrum (FHSS). In yet another embodiment, the wireless component implements direct-sequence spread spectrum (DSSS).

In one embodiment, the wireless communication is secured from tampering or undetected modification. In another embodiment, the wireless is completely encrypted to prevent unauthorized reading of the data. Non-limiting examples of wireless communication security include WEP and WPA style security methods as well as methods incorporated into the communication protocol standards implemented by the wireless components. One skilled in the arts will see that other public/private key encryption, asymmetric and symmetric key encryption methods are within the scope of this invention.

Non-limiting examples of wireless protocols include: Wi-Fi, 802.11 family of protocols, Bluetooth, Wibree, DECT, WiBro, WiMAX, UMTS-TDD, HSPA, EV-DO, Satellite, IR, LTE, DNS, TFTP, TLS/SSL, FTP, Gopher, HTTP, IMAP, IRC, NNTP, POP3, SIP, SMTP, SNMP, SSH, TELNET, ECHO, RTP, PNRP, rlogin, ENRP, TCP, UDP, DCCP, SCTP, IL, RUDP, RSVP, IP (IPv4, IPv6) ICMP, IGMP, ICMPv6. Other non-limiting examples of cellular protocols include: Global System for Mobile Communications (GSM), General Packet Radio Service (GPRS), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/TDMA), and Integrated Digital Enhanced Network (iDEN).

In another embodiment, the DPC 10 communicates to Bluetooth enabled devices such as wireless headphones.

Referring back to FIG. 1, in one embodiment, the DPC 10 has an antenna 34 external to any chip set and is connected to the wireless component 210 in the core 18. In one embodiment, the antenna 34 extends between the front side display16a and back side disply16b display, or the front display 16a and any static back side, in the case of a single display DPC10. In another embodiment, the antenna 34 is enlarged for increased range capabilities.

In other non-limiting embodiments, there is a plurality of components encompassed in a single chip. In one non-limiting example, the functions of the main processor 200, the wireless communication, and the touch microcontroller 208 are performed by a single chip which may or may not have multiple cores or processors.

In one embodiment, the DPC 10 has a small physical metal contact plate 32 through which it can communicate which in contact with corresponding contact on another device. In another embodiment, the contact connection is used for charging the battery 30. In another embodiment, the contact plate 32 is used for both communication and charging the battery 30. In one non-limiting example, the charge and the communication do not occur simultaneously. In another non-limiting example, the communication and charging occur effectively at the same time, although it may be time-shared. In one embodiment, a card shoe 300 (FIG. 3) is modified to charge and/or communicate with a DPC 10 while it is in the shoe 300 before it is drawn out of the shoe 300. In another embodiment, the DPC 10 metal contact plate 32 makes contact with a longer corresponding plate 302 on the shoe 300 as it slides out the shoe 300. FIG. 3 is a diagram of a non-limiting example of such a modified card shoe 300. In prior art, a card shoe is a box appropriately sized and shaped to hold a deck of playing cards 304 so that one card 10 is available at the end to be pulled out by the dealer. The deck of cards 304 is pushed to the end by a back plate 306, which is in turn pushed by some type of spring device 308. The shoe 300 is modified to accommodate dynamic playing cards DPCs 10 with a contact 302 aligned so that it touches the corresponding contact plate 32 on the DPC 10. In one embodiment, the length of the contact 302 on the shoe 300 is determined based on the time needed to initiate and complete any communication and data transfer. This is a function of speed of communication and amount of data to be transferred. In another embodiment, the DPC 10 is laid on a contact point to initiate charging and/or communication. Non-limiting examples of the metal contacts are copper and brass, possibly plated with nickel, tin, gold, or silver.

### System Architecture

FIG. 5 is a diagram of one embodiment of the system architecture. In the preferred embodiment, the DPC 10 communicates wirelessly over a wireless network which gives allows the DPC 10 to communicate directly or indirectly to various back end computers, servers, and systems as well as other DPC's 10 and devices such as mobile telephones.

In one embodiment, the wireless network uses one or more of the previously mentioned wireless protocols and their associated technologies. In another embodiment, there is plurality of wireless networks. In a related embodiment, the multiple physical networks are combined virtually into one or more virtual networks. In alternative embodiment, multiple virtual networks are implemented on a single physical network. In the preferred embodiment, the DPC 10 communicates to one or more wireless network access points shown as antenna 500. In one non-limiting example, the antenna 500 are distributed across the expected play area or multiple play areas, such as a casino floor. In another embodiment, the DPC 10 communicates to an RFID receiver 502. In one embodiment, RFID receivers 502 are on tables where one or more DPC's 10 are intended to be physically located. In another embodiment, the RFID receivers 502 are located around the expected play area.

### Communication with DPC Manager

In one embodiment, the DPC 10 communicates to a DPC Manager 504. In one embodiment, the DPC Manager 504 keeps track of and manages all DPC's 10 at a gaming establishment. For a DPC Manager 504 to manage a DPC 10, it performs one or more of the following functions: enable or disable the DPC 10, maintain and communicate global settings, maintain and communicate DPC-specific settings, maintain official code signatures for authorized DPC 10 software, interrogates the DPC 10 at defined and/or random times for the authenticity of its software, conducts periodic randomness checks, downloads operating system, micro-controller software, driver, application, etc authorized updates to the DPC 10, maintains current status of the DPC 10, including location, orientation, contents of front and back display 16a, b, receives log entries from the DPC 10, instructs the DPC 10 to show or hide all or portions of its front and/or back display(s), routes, processes and issues commands, and/or translates communications from other systems to the DPC 10, maintains location restrictions and/or associations (e.g. the DPC 10 is supposed to be at this table), maintains player or dealer associations (e.g. the DPC 10 is currently associated with this player and/or this dealer or is still in the shoe 300), tracks face value of the DPC 10, maintains which deck 304 or decks it is a member of.

In one embodiment, the DPC Manager 504 stores all application code and/or operating system code, except possibly some bootstrap code. The DPC 10 boots from the wireless network and downloads the latest approved application and/or operating system code from the DPC Manager 504. One non-limiting example of a DPC Manager 504 is the Bally Download and Configuration manager available from Bally Gaming, Inc. of Las Vegas, Nev., modified to track and manage DPC's 10.

In one embodiment, an RFID receiver 502 reads a plurality of DPC RFID tags 210 and communicates their proximity to the central DPC Manager 504, and as such the DPC Manager 504 can determine their locations. In one embodiment, the DPC Manager 504 communicates a DPC's 10 location back to the DPC 10 through a wireless network or equivalent wireless communication method. In another embodiment, the DPC Manager 502 communicates a subset of all DPCs 10 locations back to a certain DPC 10 so that the DPC 10 can know other DPCs 10 that are nearby.

In one non-limiting embodiment, the DPC 10 is restricted to a certain physical location. The DPC Manager 504 is aware of the DPC's 10 location and if it is within its defined region. In this example, the DPC Manager 504 is aware that the DPC 10 has left the region subject to and based on the gaming establishment's business rules or regulatory rules, the DPC Manager 504 disables the DPC 10. Some non-limiting examples of location restrictions include a casino gaming floor, a specific pit, a specific table. In another embodiment, the DPC Manager 504 combines data on a player's or dealer's proximity with the DPC 10 location so that it can detect if a DPC 10 is near its associated player or dealer. If not, it disables the DPC 10. In a related embodiment, the DPC Manager 504 combines data on a player's or dealer's proximity, combined with the DPC 10 location as well as acknowledgment from DPC 10 that it is being touched or held to determine if the DPC 10 is being touched or held by its associated player or dealer. If not, it disables the DPC 10.

Non-limiting alternatives for disabling the DPC 10 is to simply conceal the face value and display an alert message on the front and/or back display 12, 14 until the DPC 10 returns to the appropriate location, disable the DPC 10 and require some management process before wirelessly re-enabling, or completely disable the DPC 10 and require a special physical and/or manual process to re-enable the DPC 10. In another embodiment, the DPC Manager 504 notifies other system components and services, and possibly other DPC Managers 504 that the DPC 10 has been disabled and is removed from play or that it has been enabled or re-enabled and is in or available for play.

In one embodiment, the DPC Manager 504 communicates the information, text, graphics, images, video, animations, or any combination thereof, collectively referred to as content, to the DPC 10 for immediate or deferred display and instructs the DPC 10 when and what to display. In an alternative embodiment, the DPC 10 determines what content to display and when to display it. In yet another embodiment, a lead DPC 10 determines what content the DPC 10 will display and when to display it.

In one embodiment, the DPC Manager 504 is aware of the location of each DPC 10 and instructs the DPC 10 to show or conceal its front and/or back display 12, 14 based on its location. In an alternative embodiment, the DPC 10 is environmentally aware and determines to show or conceal its front and/or back display 12, 14. In one non-limiting example, the DPC 10 is in a storage area or holding device, such as card shoe 300, and not assigned to a player or dealer and is not in play. In this case, the DPC 10 turns off or refrains from updating its front and back display 12, 14 since it is not visible to anyone. Another non-limiting example the face display 12 is not turned on or updated when it is face down. Similarly, the back display 14 is not turned on or updated when it is face up. In another embodiment, such situations are also not included in being sent, do not receive, or do not respond to certain communications. In one non-limiting example, a DPC 10 knows that it is in a modified card shoe 300 so it disables its wireless communications. When the DPC 10 is pulled out of the shoe 300, it communicates or otherwise knows through the physical metal contact 302 that it has exited the shoe 300 and then turns on its wireless communication. One advantage of such embodiments and examples is that power is conserved by not updating that portion of any of the front and/or back display 12, 14.

In one embodiment, the content is dynamic and the DPC 10 must begin showing the content at the appropriate point in time. One such example is where the content is a 100 frame animation. At the time when the DPC 10 should begin displaying the animation, the animation should be at frame 27, for a variety of possible reasons. In one embodiment, the DPC Manager 504 synchronizes the animation for the DPC 10.

In one embodiment, the DPC Manager 504 provides the appropriate place in the content sequence to begin displaying. In another embodiment, a designated lead DPC 10 provides this, while in yet another embodiment the DPC 10 itself understands where in the content sequence it should begin displaying. In one embodiment, the sequence start is slightly in the future, by specifying a delayed sequence start, possibly a few milliseconds, to accommodate delay encountered in processing the command. In an alternative embodiment, the DPC 10 has an internal clock (not shown) either as a separate miniaturized component or as part of another component so that it knows the exact time and the display instruction or determination includes both a sequence start location and a start time as well.

In one embodiment, the DPC Manager 504 coordinates activities between one or more DPCs 10. In one embodiment, the DPCs 10 communicate with each other to collaboratively coordinate such activities. In yet another embodiment, the DPCs 10 communicate pertinent data to the designated lead DPC 10 which coordinates such activities among the other DPCs 10. One non-limiting example of such activity coordination is the display of content spanning across the front, back, or both displays 12, 14 of more than one DPC 10 providing the visual effect of a larger single display. In one embodiment, one or more DPCs 10 are aware of their locations relative to each other, including distance between or overlap and directional orientation relative to each other. Each DPC 10 is able to distinguish between the display area visible and that which is obscured by another card. In another embodiment, the DPC Manager 504 provides the location and directional orientation relative to each other to the applicable DPCs 10. In one embodiment, one or more DPCs 10 identify other candidate DPCs 10 to work with to create a single display effect. In an alternative embodiment, such identification and/or determination are collaborative efforts between one or more DPCs 10 and the DPC Manager 504. In one embodiment, the DPCs 10 communicate with each other to establish which portion, position, and size of the content each will show on its display and to synchronize its presentation so that the combined effect of each DPC 10 is perceived as a single informational message, text message, graphic, image, video, or animation, accounting for overlaps or gaps between the DPCs 10. In another embodiment, the lead DPC 10 provides the portion, position, and size of the content to each DPC 10 and the synchronization data. In yet another embodiment, the DPC Manager 504 provides this management. In yet another embodiment, a plurality of the aforementioned methods are employed to collectively provide this management.

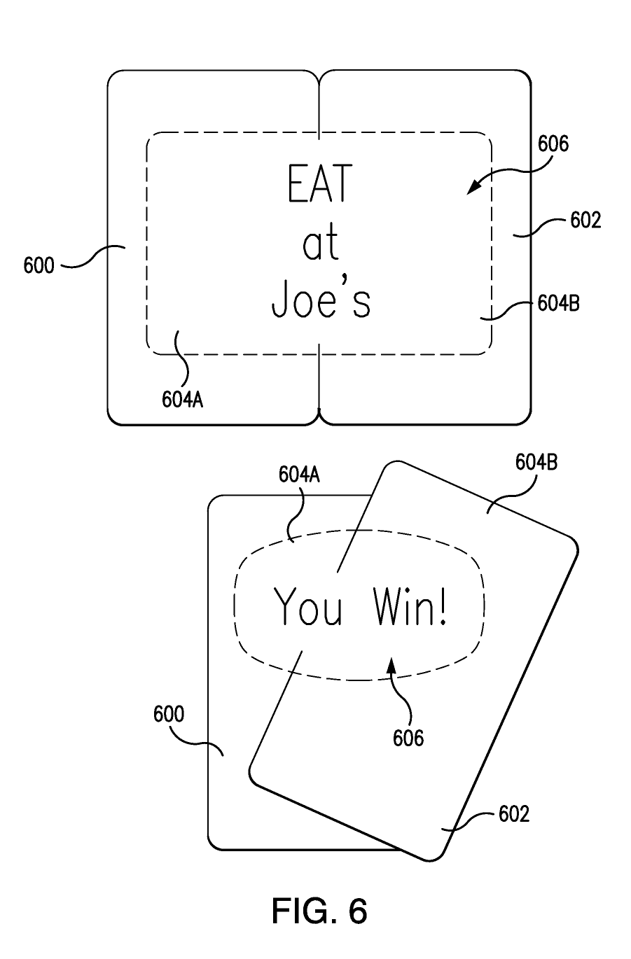

FIG. 6 is a diagram of two examples of single images spanning two DPCs 10. The first example is two DPCs 600, 602 that are physically positioned side by side. One DPC 600 displays a visual message 604a centered along its long edge, but flushed right. The other DPC 602 displays a corresponding visual message 604b also centered along its long edge, but flushed left. The resulting visual effect of the side by side images is a single image 606 spanning both DPCs 600, 602 that advertizes “Eat at Joe's”. In the second example, two DPCs 600, 602 are positioned so that DPC 602 is partially overlapping DPC 600. One DPC 600 is displaying one image 604a and the second DPC 602 is displaying its image 604b such that the result is a single celebratory image 606 spanning both DPC's 600, 602.

In one embodiment, the DPC 10 knows which portion of its front or back display 12, 14 is not visible due to being obscured by another DPC 10 and does not modify the graphic or video display in the obscured region. One advantage of such an embodiment is that power is conserved by not updating that portion of the display. In another embodiment, the DPC Manager 504 is aware of which portions of a given DPC 10 are obscured by another DPC 10 and instructs the DPC 10 to not update that portion of its display. In an alternative embodiment, the DPC Manager 504 alters the content, image, video, or animation so that the obscured portion of the DPC's 10 front or back display 12, 14 is not modified.

This invention allows for a plurality of DPC Managers 504 to keep track of and manage the DPCs 10 at a gaming establishment. In one embodiment, a DPC 10 is managed by one and only one DPC Manager 504. In an alternative embodiment, a DPC 10 may be managed by a plurality of DPC Managers 504, some simultaneously. In one non-limiting embodiment, each DPC Manager 504 is assigned a subset of DPCs 10 to manage. In another embodiment, the DPC Manager 504 manages the DPCs 10 located in a region of the gaming establishment. In yet another embodiment, the DPC Manager 504 manages one or more decks and the DPCs 10 in those decks.

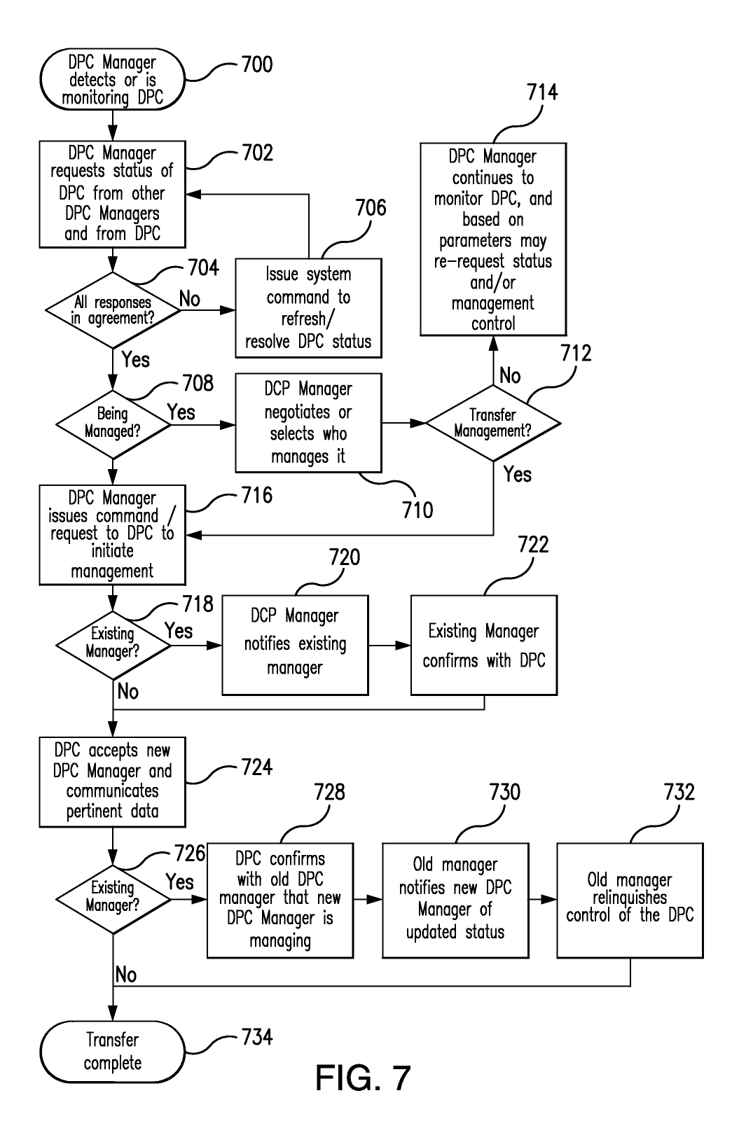

One aspect of this invention allows for the management of a DPC 10 to be transferred between two or more DPC Managers 504. FIG. 7 is a flowchart describing one embodiment of the process of a DPC Manager 504 initiating management control of a DPC 10, transferring from an existing manager if necessary. In one embodiment, a DPC Manager 504 detects a DPC at 700. In an alternative embodiment, the DPC Manager 504 is already aware of the DCP 10, but some status has changed causing the DPC Manager 504 to consider taking management control of the DPC 10 at 700. The DPC Manager 504 may be configured to periodically pool for DPCs 10 in its area of control. One non-limiting example is the DPC Managers 504 manage DPCs 10 in a certain physical area. A certain DPC 10 is in both regions. The non-managing DPC Manager 504 detects that the DPC 10 is moving out of the managing DPC Manager's 504 region and more into its region; hence it elects to consider taking management control.

After determining to consider taking management control of the DPC 10, the DPC Manager 504 sends out a request for status for the DPC at 702 from other DPC Managers 504. In one embodiment, the request for status is also sent or is alternatively sent to the DPC 10 itself. In one embodiment, the status provided includes at least the DPC 10 identification and identification of the managing DPC Manager 504. In another embodiment, other data provided includes one or more of the following: associated player or dealer, face value, physical location, display status, other identifying information, hardware configuration, communication parameters, security information such as, but not limited to keys and passwords. In an alternative embodiment, the DPC 10 is managed by multiple DPC Managers 504 and the data in the status response reflects the multiple DPC Managers 504.

Once the DPC Manager 504 receives all the responses from its request, it performs a check to ensure agreement among the respondents at 704. If there is disagreement, the DPC Manager 504 must initiate a process at 706 to resolve the differences. It then reissues the request. In an alternative embodiment, the DPC Manager 504 is able to resolve the differences and continue with the process (not shown).

Assuming the respondents are in agreement or disagreements have been resolved with regards to the status of the DPC 10, the DPC Manager 504 must check if the DPC 10 is currently being managed at 708. If it is, then it must determine at 710 if it can transfer the management control of the DPC 10. In one embodiment, the existing DPC Manager 504 makes the decision to allow the new DPC Manager 504 to take management control. As a result, the new DPC Manager 504 negotiates with the existing manager to determine which will control the DPC 10. In an alternative embodiment, the DPC 10 itself makes the decision to allow the new DPC Manager 504 to take management control, so the DPC Manager 504 must negotiate with the DPC 10. In yet another embodiment, the new DPC Manager 504 is able to make the decision itself, based on status responses. In any case, the DPC Manager 504 has either negotiated to transfer management control or not at 712. If not, the DPC Manager 504 continues to monitor the DPC 10 at 714 for any change in status that might cause the DPC Manager 504 reattempt negotiating for management control of the DPC 10.

In the event that the DPC Manager 504 has negotiated to transfer management control at 712 of the DPC 10 to itself or the DPC 10 is not currently be managed at 708, then the DPC Manager 504 beings the process of initiating management control of the DPC 10. It begins this by issuing a command/request to the DPC 10 to initiate management at 716. If the DPC 10 is being managed at 718 the DPC 10 notifies the existing manager of the request at 720 and the current managing DPC Manager 504 confirms with the DPC10 at 722. In the case where the current managing DPC Manager 504 does not confirm the request, the DPC 10 must enter an error state to resolve the inconsistencies (not shown).

The DPC 10 accepts the new management control from the DPC Manager 504 and communicate any pertinent data to the new managing DPC Manager 504 at 724. Non-limiting examples of possible data exchanged include, but are not limited to: current state, current face value, any face value sequence, location, orientation, direction, associated player/dealer, hardware information, etc. If the DPC 10 was previously being managed at 726, the DPC 10 confirms the transfer with the old DPC Manager 504 at 728. The old DPC Manager 504 confirms the transfer complete with the new DPC Manager 504 at 730 and the old DPC Manager 504 relinquishes control of the DPC 10 at 732. In an alternative embodiment, the new DPC Manager 504 confirms the transfer with the old DPC Manager 504 at 728. The transfer of management from one DPC Manager 504 to another is then complete at 734.

In alternative embodiments, the communication with the DPC Manager 504 is not wireless, but rather through a method which requires physical contact. In one specific embodiment, the DPC Manager 504 communicates with the DPC 10 through the metal contact 32. In one non-limiting example, the contact occurs as the DPC 10 is exiting a modified card shoe 300. As a person pulls the DPC 10 out of the card shoe 300, the DPC 10 contact 32 physically touches the shoe contact 302. As it does, the DPC Manager 504 communicates data to the DPC 10. Non-limiting examples of data communicated include front display 12 content, e.g. card face value and suit, back display 14 content, physical location, assigned player/dealer and associated data including biometric and other identification, data, skill data, and personalization data. In another embodiment the DPC 10 communicates data to the DPC Manager 504 during this process. Non-limiting examples include DPC 10 identifying data, security checks, etc. In another embodiment, the DPC 10 is placed on a physical contact on the table so that the DPC Manager 504 can communicate to/with the DPC 10.

The DPC Manager 504 may act as a routing device, receiving, forwarding, interpreting, translating, or otherwise facilitating communication between a DPC10 and server, workstation or any other device on the network, or another DPC 10 and such communication may be wired or wireless or combination. Consequently, it is disclosed that any communication between a DPC 10 and server, workstation or any other device on the network, or another DPC 10 that is referred to as direct communication may or may not utilize one or more DPC Managers 504 as intermediaries for that direct communication whether explicitly mentioned or not.

### Communication with Game Server

With reference to FIG. 5, in one embodiment, the DPC 10 communicates to a Game Server 506. In an alternative embodiment, communication between the DPC 10 and the Game Server 506 is through one or more DPC Managers 504. In either case, the DPC 10 is considered communicating to a Game Server 506.

The Game Server 506 oversees, manages, or directly instructs the DPC 10 with regards to game logic. One skilled in the art will recognize that this invention allows any and all games capable of being played on or with cards, including playing cards as defined and referenced above, or specialized decks of cards. In one embodiment, a Game Server 506 manages one type of game. In one embodiment the Game Server 506 knows the game context. The game context consists of one or more of, but not limited to, the following: the value of each hand in play for all players and dealer (competitive hands), the game rules, game odds, number and type of decks in play, and what is currently going on in the play of the game (e.g. a certain player is being dealt another card), what needs to happen next (e.g. a certain player must make a decision while the remainder of the players wait). Any subset of these is called a partial game context. One non-limiting example of a partial game context is a particular player's hand and the dealer's hand, and the state of game play relative to a certain player. In another embodiment, the Game Server 506 communicates the game context or a partial game context to one or more DPC's 10. In another embodiment, the Game Server 506 communicates the same information to each DPC 10, but in an alternative embodiment, the Game Server 506 communicates selective information and creates a partial game context customized for a given DPC 10 or hand. In yet another embodiment, a DPC 10 in a hand is selected as the lead DPC 10 for that hand and the Game Server 506 communicates the game context or a partial game context to the lead DPC 10, which may or may not communicate all or a subset of the data to the other DPCs 10 in the hand. In still another embodiment, a given DPC 10 or a lead DPC 10 constructs a partial game context or the entire game context by communicating with one or more DPCs 10. This invention allows for a given DPC 10 to create its partial game context or the entire game context from a plurality of sources and through a plurality of methods.

In another embodiment, the Game Server 506 manages a plurality of games. This invention allows for a DPC 10 to communicate to one or more Game Servers 506 simultaneously or sequentially. In one embodiment, the Game Server 506 tracks which game each DPC 10 is being used in. In another embodiment, the Game Server 506 changes or instructs the DPC Manager 504 or DPC 10 to change some or all of its representation on the front and/or back display 12, 14. In another embodiment, the Game Server 506 downloads game specific logic and or graphic or other content based on one or more game types that DPC 10 may be playing.

In one embodiment, the DPC 10 may be involved in two games simultaneously In one embodiment the card value is the same for each game. In another embodiment, the DPC 10 has more than one card face values and the front display 12 is divided so that the player/dealer can see all the card face values at the same time. In another embodiment, the DPC 10 only displays a subset of the card face values at a given time. In one embodiment, the Game Server 506 coordinates between the actions in the multiple games and displays the appropriate face value at the appropriate time. In another embodiment, the player is able to select the appropriate card face value to display, based on his preference and current game play action.

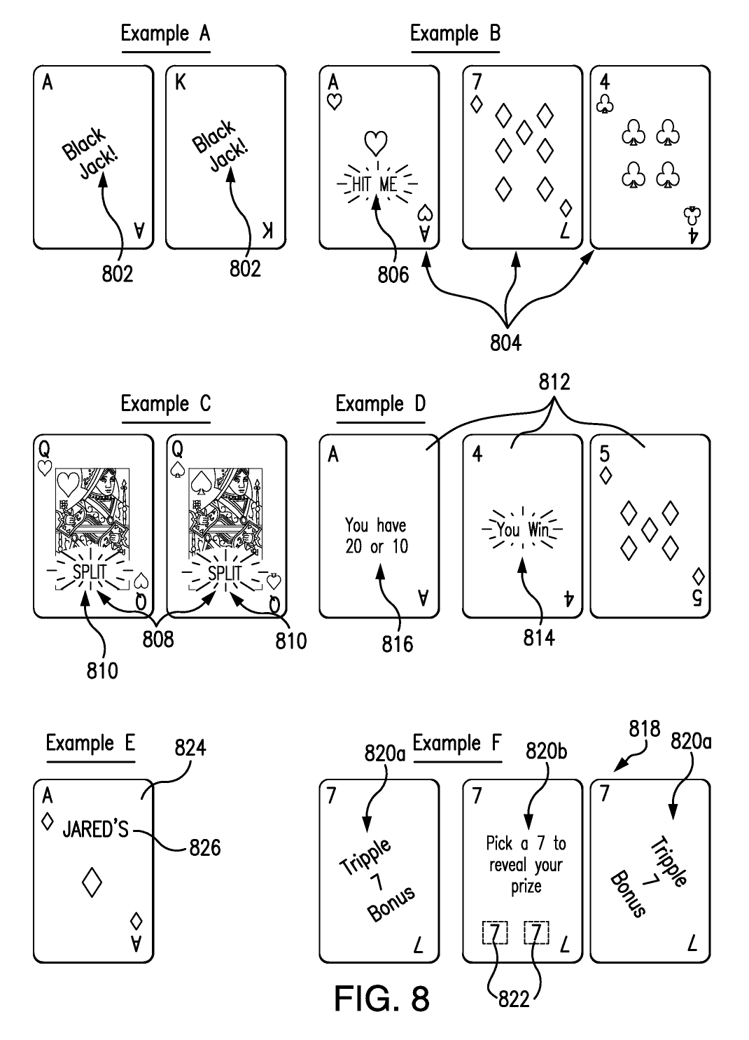

In one embodiment, the Game Server506 instructs the DPC 10 to display game-related messages. Game-related messages include, but are not limited to celebrations, hints, help, instructions, or any other game-related, game-specific, partial game context dependent or independent information, or any combination thereof. FIG. 8 provides some non-limiting examples of messages or information displayed on a player's hand of a Black Jack game. In example A, the player is dealt a two-card hand 800 consisting of an Ace and King. The Game Server 506 recognizes that the player has a winning hand and instructs the DPC's 10 in the hand 800 to display a celebratory “Blackjack!” message 802. In example B, the player currently has three cards in his hand 804 consisting of an Ace, a Seven, and a Four. The Game Server 506 recognizes that the total value of the hand 804, under the rules of Blackjack, is either 12 or 22 (since an Ace can have a value of 1 or 11). The Game Server 506 instructs one of the DPCs 10 to display a game hint or game instruction “Hit Me” message 806. In example C, the hand 808 consists of two Queens. The Game Server 506 understands the game context and that the optimal decision is that the player split the two cards. It instructs the DPCs 10 in the hand 808 to display the game hint “Split!” message 810. In example D, the player currently has three cards in his hand 812 consisting of an Ace, Four, and Five. The Game Server 506 recognizes that the total value of the hand 812 is either ten or twenty. The Game Server 506 compares the player's total to the dealer's (not shown) and in the case is higher and therefore is a winner. It instructs one DPC 10 to display a celebratory message “You Win!” 814 and another DPC 10 to display a game hint or game informational message “You have 20 or 10” 816. In another non-limiting example (not shown) the game is a 5-card stud poker game. The game hint is “Hold Me” and/or “Discard Me” and is specific to each DPC 10. In one embodiment, all the DPCs 10 in a hand display all messages, whereas in an alternative embodiment, only a subset of the hand displays a given game-related message. In yet another embodiment, a DPC 10 may display a plurality of game-related messages.

In an alternative embodiment, one or more of the DPCs 10 which make up a player's hand 800, 804, 808, 812 are aware of the other cards in the hand and their face values as part of a partial game context. The DPCs 10 know the game context or a partial game context and determine that it should display a game-related message. In yet another alternative embodiment, the lead DPC 10 in a hand knows the game context or a partial game context and instructs the other cards in the hand to display a game-related message. In another embodiment, the Game Server 506 instructs the lead DPC 10 to display a game related message, which in turn sends the command to one or more of the other DPCs 10 in the hand.

In another embodiment, the Game Server 506 tracks the face value of a given DPC 10. The Game Server 506 assigns the face value to a DPC 10 and instructs the DPC 10 front display 12 to display a face value to the assigned value. In one embodiment, the DPC 10 assigns its own face value randomly using an internal random number generator 212. In yet another embodiment, the lead DPC 10 assigns the face values and communicates them to the other DPCs 10 in a hand and/or back to the Game Server 506. In another embodiment, the Game Server 506 communicates a list of card assignments to a DPC 10 or to a lead DPC 10. The DPC 10 assigns its own face value or the lead DPC 10 assigns face values to other DPCs 10 by iterating through the list of card assignments. In one embodiment, the Game Server 506 instructs the DPC 10 to change its face value, but does not assign the face value, leaving the face value to be assigned by the lead DPC 10 or the DPC 10 itself.

In one embodiment, the DPC 10 communicates its face value back to the Game Server 506. In the case where the Game Server 506 did not assign the face value, it is for the purpose of providing information the Game Server 506 of the face value. In the case where the Game Server 506 originally assigned the face value, the purpose is for confirmation, security, and/or authentication that the DPC 10 set and/or displayed the face value as assigned. In another embodiment, the Game Server 506 queries the DPC 10 for its face value and the DPC 10 responds with the face value being displayed or assigned. In one embodiment, the Game Server 506 records the face value originally assigned, if applicable, and the face value the DPC 10 communicated for regulatory purposes such as replay, managing disputes, or other troubleshooting purposes.

In one embodiment, the Game Server 506 communicates the face value assignments through one or more DPC Managers 504 using wireless or wired methods previously described is the DPC Manager 504 discussion. In a non-limiting embodiment, the DPC 10 is instructed to set its face value as it is being dealt to the player. In another embodiment, the DPC 10 is instructed to set its face value while it is being held by or in the near vicinity of its assigned player as part of the player's hand. In alternative embodiments, the lead DPC 10 performs the role of the Game Server 506 in the preceding embodiments. In another embodiment, the dealer inserts the DPC 10 into a device or places the DPC 10 on a special contact so that the DPC 10 can receive its card assignment. In one embodiment, the DPC 10 delays displaying its face value for a certain period of time after the assignment to allow time for the DCP 10 to be placed face down after exiting the device or being removed from the contact. In another embodiment, the player places the DPC 10 in a similar device or on a similar contact. In another embodiment, each player is assigned a specific contact, and the Game Server 506 and/or DPC Manager 504 determines which player the DPC 10 is assigned to by which contact the DPC 10 communicates through.

In one embodiment, the assigning of face values or the instruction to change face value is in response to dealing a card. In one embodiment, the DPC 10 is physically dealt to a player. The DPC 10 sets its face value at some point before the deal, as the card is being physically dealt, or after the card has been dealt and is part of the player's hand. In one non-limiting example, the DPC 10 is aware of its motion and changes the display of its face value either while it is in motion or immediately or soon after it stops or slows to specific speed. In another embodiment, the DPC 10 doesn't display its face value until the assigned player or dealer touches the card. In another embodiment, the Game Server 506 instructs the DPC 10 when to display its face value. In one non-limiting example, the Game Server 506 delays that instruction until all the physical DPCs 10 in a player's hand, or dealer's hand, or all DPCs 10 that will be in play are physically dealt. In another embodiment, the DPC 10 is part of a player's hand for an extended period (e.g. longer than a single game hand) and the face values of the DPC 10 change over time. One non-limiting example is the case of a 5 card stud poker game where a player maintains five cards in his hand at all times. The player continues to hold the same five physical DPCs 10 (either by physically handling them or by having them sit in the vicinity of the player), but the values of the DPCs 10 change to simulate the player being dealt different cards or a new hand of cards (virtual dealing).

In another embodiment, a subset of DPCs 10 rearrange or exchange their face values. In one non-limiting example, this achieves a shuffling of the deck. In another non-limiting embodiment, the DPCs 10 that make up a hand have their face values rearranged in an effort to visually sort themselves. In this embodiment, the set of face values represented by the DPCs 10 in the hand does not change, but the assignment of those face values to particular DPCs 10 changes so that the DPCs 10 in a hand holding are sorted appropriately according to face values in the player's hand or on the table without the player or dealer having to physically move the cards. The sort order is part of or defined by a game context. In one non-limiting example, a standard poker game would sort a 2 towards the end, however, in a Deuces Wild, game the 2 might be sorted higher up. In one embodiment, the sort shows the best possible hand as it currently stands. In another embodiment, the sort shows moves any card values that should be discarded (assuming the game allows for discards) to a certain location. In one embodiment, the sort order represents a pleasing or orderly visual appearance. In another embodiment, the sort order suggests a certain play strategy. In yet another embodiment, the sort order achieves or attempts to achieve a plurality of such goals.

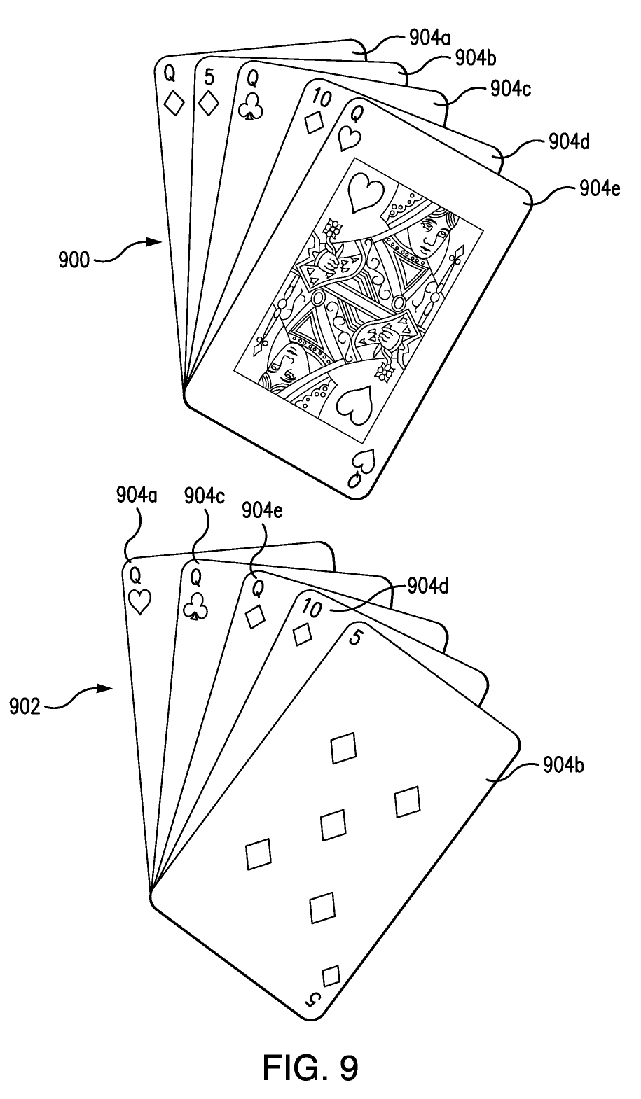

In one embodiment, the Game Server 506 is informed of one or more of the following environmental attributes of the DPC's 10: physical location, physical orientation, direction pointing, current motion, how the player or dealer is holding the entire hand or how the DPCs 10 are laid out and the order of the DPCs 10 from the holder's perspective, and/or any other such data relative to other DPCs 10 or assigned players/dealer. The Game Server 506 is provided this information from one or more DPC Managers 504, one or more DPCs 10, or any combination thereof. With this physical environmental information and a partial game context, the Game Server 506 determines the optimal sort order of the DPCs 10 in a hand. The Game Server 506 assigns the physical DPCs 10 their new face values to affect this visual sorting and communicates the new assignments to the DPCs 10 or lead DPC 10. The lead DPC 10 communicates the new face values to the other DPCs 10 for a visual sort. In yet another embodiment, each DPC 10 is environmentally aware and achieves a visual sort by communicating with the DPC 10 on either side of it. A collective sort is achieved through a local sorting algorithm. One non-limiting example is bubble sort, where adjacent values exchange places if the sort order demands it and the collective affect is a completely sorted list. FIG. 9 depicts a 5 card stud poker hand of DPCs 10 pre-sorting at 900 and post-sorting at 902. In this example the following DPCs 10 are the same physical DPCs 10: 904a-904e. DPCs 10 at 900 depict the hand 904a-e as dealt and are assigned these respective values, from left to right: Queen, Five, Queen, Ten, and Queen. In one embodiment, the optimal sort is to group the Queens together as a three-of-a-kind. After the sorting algorithm is applied either by the Game Server 506, the lead DPC 10, or individually by each DPC 10 with its adjacent DPCs 10, the final result is that the physical DPCs 10 904a-e have not physically moved, but rather their face values have been rearranged and are assigned the respective values, from left to right: Queen, Queen, Queen, Ten, and Five.

In an alternative embodiment, the Game Server 506 downloads the UI (user interface) logic, game response logic, game rules, business logic or rules, user preferences involved in the aforementioned embodiments and examples, but not limited to those embodiments and examples, to the DPC 10 so that the DPC 10, nearby DPCs 10, the DPC Manager 504, the Game Server 506, or some combination thereof controls or guides what/when/how the DPC 10 displays content and communicates. In another embodiment, the Game Server 506 downloads the data to the DPC Manager 504. In one embodiment, the Game Server 506 still coordinates timing and initiates when and what the DPC 10 should display or do. In an alternative embodiment, the DPC 19 or DPC Manager 504 controls all of that.

In another embodiment, the DPC 10 is able to detect touches and the player communicates play actions through touching the DPC 10. In one non-limiting example, the DPC 10 displays a graphical object, such as a representation of a button, and detects with the player or dealer touches the graphic or surrounding area to initiate the action. In this way, the DPC 10 is able to provide the player or dealer opportunities to initiate certain actions or indicate decisions or preferences. In one non-limiting example, a DPC 10 that is part of a poker hand may display a game-related message that prompts the player to Hold or Discard the card. The user is able to touch the desired action. In one embodiment, the DPC 10 communicates the user input to the Game Server 506 directly or indirectly through the DPC Manager 504 or a lead DPC 10. The Game Server 506 then initiates a response to the user input. In the current example, the Game Server 506 will assign the DPC 10 a new face value and instruct the DPC 10 to set and change its display. In another embodiment, the lead DPC 10 may respond to the user input. In yet another embodiment, the DPC 10 responds to the user input. In this example, the DPC 10 assigns itself a new face value or requests a new face value from the Game Server 506, lead DPC 10, or DPC Manager 504. In an alternative embodiment, a plurality of methods is employed to respond to user inputs.

In another embodiment, there is a separate device, such as a key pad, touch screen connected to a separate CPU, a wireless input device communicating to the DPC 10, lead DPC 10, one or more DPC Managers 504. In one embodiment, the player has a 5 button key pad embedded into the table in front of him allowing him to indicate to hold or discard an associated DPC 10. The DPCs 10 are placed next to the associated keys. In one embodiment, the DPC 10 is environmentally aware and is associated to the closest button. In another embodiment, the association is determined by the order the DPCs 10 are assigned to the player and/or dealer. In one embodiment, the DPC 10 visually indicates where it should be laid based on this order. One skilled in the arts will recognize that this invention allows for the association or binding of a DPC 10 to any external device, such as but not limited to other input devices, display (e.g. OLED, LCD, eInk), card readers, communication devices, audio speaker, personal Bluetooth or other wireless devices. In an alternative embodiment, a plurality of input methods is employed for a player or dealer to inform the DPC 10, Game Server 506, and/or DPC Manager 504 of preferences and decisions.

In another embodiment, the Game Server 506 is a completely automated display tables (similar to the automated Poker product provided by PokerTek located in Matthews, N.C., USA). The DPC 10 coordinates its display with the virtual cards presented on the automated table. In one non-limiting example, the automated display table is a 5 Card Stud Poker game, and incorporating DPCs 10. In this example, the players keep their physical DPCs 10 lying on the table. When the hand is over and the cards are to be collected from the players, the player keeps his physical DPCs 10 but the DPCs 10 are now blank or show a pending graphic until the next deal. In one non-limiting embodiment, the pending graphic matches the table graphic where the DPC 10 is located, so that the DPC 10 blends in with the underlying table graphic. As the automated table deals the player a new card, the table displays the graphic of a card being dealt across the table towards the physical DPC 10. The Game Server 506 times the command to the DPC 10 to display the appropriate animation so that when the table graphic seems to slide onto the physical DPC's 10 front display 12. In another non-limiting embodiment, the DPC 10 simply shows its graphic, rather than attempting to mimic the underlying graphic sliding into position on the card.

In alternative embodiment, the DPC 10 does not represent a traditional playing card, such as a 52 card deck of cards, but rather one or more of the following: a keno card, a bingo card, a sports-betting ticket, or a plurality of any of these.

In an alternative embodiment, the DPC 10 communicates to some of all of the Game Servers 506 through one or more DPC Managers 504. In yet another alternative environment, no Game Server 506 exists and the above embodiments are achieved through collaboration between and among two or more DPC's 10.

### Communication with Player Database, DPC Player Tracking and Personalization

Referring back to FIG. 5, in one embodiment, the DPC 10 communicates to a Player Tracking Server 508. The DPC 10 communicates player or dealer choices, including time elapses to make the choices to the Player Tracking Server 508 and related database for storage, later retrieval, reporting, and analysis. There may be multiple players in a game and hence the DPC 10 and/or DPC Manager 504 are aware of individual players and a session is established with the DPC 10, DPC Manager 504, Game Server 506, Player Tracking Server 508, or related systems, or any combination thereof. In any case, the player may or may not have one or more associated records in the Player Tracking Server 508.

Where the DPC 10 and/or DPC Manager 504 are not aware of the player's identity, they may establish an anonymous session. In one embodiment, player awareness is achieved through the use of one or more player existence recognition devices. Examples of such devices include, but are not limited to, a camera recognition system recognizing an unidentified player occupying a playing location, a device detecting someone sitting in a seat, a device to capture manual input from a dealer or related employee, or any combination thereof. The device communicates the unidentified player existence to the DPC 10, DPC Manager 504, Game Server 506, and/or other system which creates a session.

In another embodiment, the DPC 10 and/or DPC Manager 504 are aware of the player's identity and establish a session for the identified player. In an alternative embodiment, the DPC Manager 504 is aware of the player's identity and creates a session for the identified player, but the DPC 10 is not and creates an anonymous session. In an alternative embodiment, the DPC 10 is aware of the player identity and creates a session for the identified player, but the DPC Manager 504 is not and creates an anonymous session. In one embodiment, the player is identified through the use of one or more of, but not limited to, the following devices or systems: a player club card (aka loyalty card, identification card) with magnetic strip and mag card reader, player club card with bar code and a bar code reader, player club card or player-owned device with embedded RFID tag and an RFID reader, player club card or player-owned device with wireless capabilities and wireless access points, optical reader that can identify and read a player club card, player club card with biometric detection system and biometric recognition system, external biometric recognition system, player club card with other wireless communication. The device communicates the player identification either directly or indirectly to the DPC 10, DPC Manager 504, Game Server 506, and/or other system which creates a session.

The player club card may be a specialized DPC 10 with all the display and communication capabilities. In non-limiting embodiment, the DPC 10 player club card and is environmentally aware, similar to other DPC's 10, knowing its location. In another embodiment, the DPC Manager 504 is aware of the DPC 10 player club card's location and identity The DPC Manager 504 determines the player associated with the DPC 10 player club card and initiates a session for the identified player. In another the embodiment, the DPC Manager 504 communicates the DPC 10 player club card identifier to the Player Tracking Server 508 and/or other system to look up the player associated with the DPC 10 player club card. In yet another embodiment, the DPC Manager 504 communicates the DPC 10 player club card and/or player identification to the Game Server 506, and/or other system which creates a session for the identified player. Conversely, similar methods and embodiments are used to determine when a player has discontinued playing and the session(s) for the identified or anonymous player is closed.

When the player session is created, one or more DPCs 10 are assigned to the player. In another embodiment, one or more DPCs 10 are assigned as the dealer deals the physical DPCs 10 to the player. In one embodiment, the DPCs 10 assigned to a player are tracked in the Player Tracking Server 508.

In one embodiment, the DPC 10, DPC Manager 504, Game Server 506, or any other system that maintains a player session, retrieves the player's preferences and settings from the Player Tracking Server 508. In one embodiment, only a subset of preferences or options is retrieved. Examples by which such subsets can be defined include, but not limited to, device or system, game, location, player tier, or any combination thereof. Changes in preferences or options are stored back on the Player Tracking Server 508. In another embodiment, preferences or options are associated to groups or players, rather than specific players. In yet another embodiment some preferences or options are associated to groups of players and others are associated to specific players. In one non-limiting example of a player preference, the player can select sorting options which are saved as part of the player's profile in the player tracking database. In another non-limiting example, the sorting options are selected and stored by type of game, such as, but not limited to, 5 Card Draw Poker, Texas Hold 'Em, Black Jack, etc. In another non-limiting example, the player has selected the style or graphics to use for the card back or the card face and its face values. In another embodiment, the Bluetooth parameters and binding information is maintain in a Player Tracking Server 508 and retrieved when needed so that the player is not required to re-bind the device.

In one embodiment, the DPC 10, DPC Manager 504, Game Server 506, or any other system that maintains a player session, accumulates tracked data and transmits the raw data and/or any accumulated or processed data to the Player Tracking Server 508 when it closes its player session. In another embodiment, such systems transmit raw and/or any accumulated or processed data to the Player Tracking Server 508 periodically or continuously during the session. In yet another embodiment, such systems send some data continuously, some data periodically, and some data after the session closes, or any combination thereof, to the Player Tracking Server 508. Non-limiting examples of tracked data are include: assigned DPC's 10, dealt face value(s), dealer and/or other competitive face values, player and or competitive decisions, games participated in, wagers made and surrounding game context, environmental data, player preferences and selections, and any other play behaviors such as time between decisions, etc.

In one embodiment, the Player Tracking Database 508 assesses skill. The skill assessor combines data from a plurality of DPC's 10, Game Servers 504, DPC Managers 506, Player Tracking Server 508, or any combination thereof, to determine the skill level of the player/dealer. This data can be used in player or dealer fraud detection, player reinvestment, suggestions back to the player, matching players for head to head competitive play, team play in the same, similar, or completely different style games, rank players, or alter the game experience in some other fashion, including but non-limited to, changing game outcomes.

A bonus may simply be an award, a separate game or additional round in a game which then may or may not provide an award which may or may not be dependent on the outcome, or a combination thereof. Non-limiting examples of awards include cashable awards, such as cash or credit, coupons, discounts, services, amenities, prizes, intangibles such as loyalty tier advancement, and any combination thereof. A bonus award may be based on, calculated from, funded by, or otherwise driven by game activity and/or the player's wagering activity. Alternatively, a bonus may not funded by the player's wagering on game activity, but rather through a separate funding source, such as a marketing budget.

### Communication with Bonus Server and DPC Bonusing

It would be advantageous to employ a bonus on a DPC 10, providing superior player experience over physical cards. In one embodiment, the DPC 10 communicates to a Bonus Server 510. In one non-limiting example the Bonus Server 510 bases and/or funds bonuses on game or wagering activity. In another non-limiting example, the Bonus Server 510 bases and/or and funds bonuses on non-gaming activity or non-gaming funds, such as a marketing budget. In another embodiment, the Bonus Server 510 bases and/or funds bonuses on both game and non-game activity or funding sources. In another embodiment the Bonus Server 510 can be considered a Game Server 506. In an alternative embodiment, the Bonus Server 510 is a marketing application.

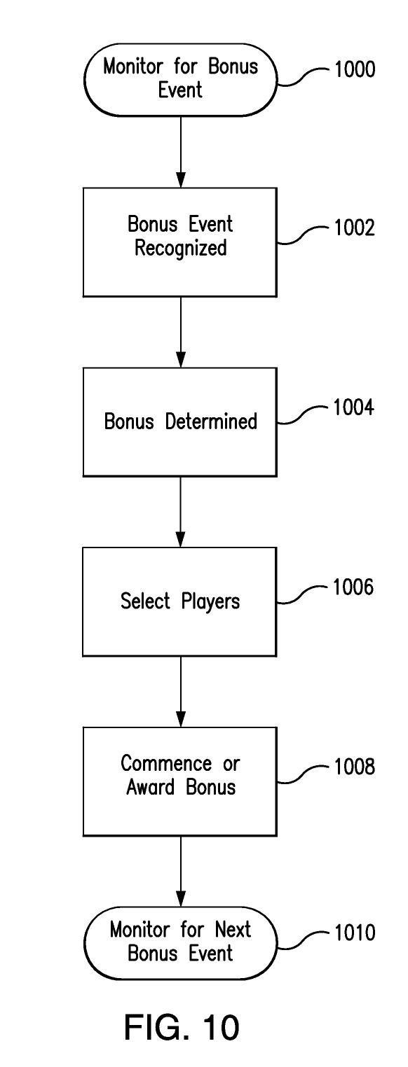

FIG. 10 is a flowchart of one non-limiting embodiment of determining and commencing a bonus, whether it is a gaming or non-gaming bonus. A bonus is commenced, in the case of a separate game or additional round in the existing game, or distributed, in the case of the bonus simply being and award, after encountering a bonusing event. In one embodiment, the Bonus Server 510 monitors for a predetermined bonus event at 1000 and recognizes at 1002 the bonus event and determines the bonus to commence or award at 1004. In another embodiment, the Game Server 506, DPC Manager 504, or other system, or any combination thereof, possibly in collaboration with the Bonus Server 510 monitor for at bonus event at 1000 and recognize the bonus event at 1002 and one or more collaboratively or independently determine the bonus to commence or award at 1004. In another embodiment, the individual DPC's 10 communicate face values, game state, and/or game activity directly to the Bonus Server 510 or Game Server 506, or to the lead DPC 10, which in turn communicates individual or accumulated face values, game state, and/or game activity to the Bonus Server 510, DPC Manager 504, Game Server 506, or other system, or any combination thereof, which individually or jointly monitor for an event at 1000 and recognize at 1002 the event.

In one embodiment, the rules defining the bonus events, awards, and other bonus definition data are provided by Bonus Server 510, DPC Manager 504, Game Server 506, or other system, or any combination thereof, to one or more DPCs 10. In one non-limiting example, one or more DPCs 10 communicate the face values, game state, and/or game activity between themselves and monitor at 1000 and recognize at 1002 the bonus event collectively, or independently. In another embodiment, the lead DPCs 10 receives face values, game state, and/or game activity from one or more DPCs 10 to monitor at 1000 and recognize at 1002 the bonus event. In one embodiment, the Bonus Server 510, DPC Manager 504, Game Server 506, or other system, or any combination thereof, determine the bonus to commence or award at 1008.

In another embodiment, one or more communicate the bonus event to one or more DPCs 10 and either the DPCs 10 collectively or the lead DPC 10 determines the bonus to award or commence.

In one embodiment, the bonusing event is triggered by a game event. One non-limiting example of a game event is a predefined sequence of face values being assigned or dealt to the player (i.e. in the player's or dealer's hand). In another non-limiting example, the bonusing event is triggered by a predefined sequence of face values being assigned or dealt to a group of players and/or the dealer. Referring back to FIG. 8, in example F the player is dealt at 818 three 7's and triggers a Triple & Bonus. One or more of the DPCs 10, lead DPC 10, DPC Manager 504, Game Server 506 and Bonus Server 510 recognize the bonus event and controls the DPC 10 front faces 12 in the bonus holding to display bonus messages “Triple 7 Bonus” 820a, “Pick a 7 to Reveal Your Prize” 820b and one or more buttons 822 which, when touched by the player, cause one or more of the DPCs 10 of the holding 818 to display prize information to the player. In alternative embodiment, the bonus event is triggered by a predefined collection of face values assigned to one or more players/dealer, independent of order assigned or dealt. Other non-limiting examples of game events include player decisions, wager amounts, dealer actions, and game results such as going bust (over 21 in Blackjack, winning, etc). One skilled in the art knows that there are many such game events. This invention allows for all such game events triggering a bonus on one or more DPCs 10 where the game events occur on the Game Server 506, on a single DPC 10, collectively over several DPCs 10 within a certain time allotment, or some other separate system contributing to the game, or some combination thereof. In another embodiment, a bonusing event is triggered by an event on a non-game system, a system event. Non-limiting examples of other such systems include Player Tracking Server 508, Bonus Server 510 (including perhaps a Lottery Server) (FIG. 5), manual or automated drawings, etc.

In one embodiment, the DPC 10 displays additional symbols beside those defined by its face value. Such symbols may be defined by the Bonus Server 510, Game Server 506, or through preferences or group definitions in the Player Tracking Server 508. Predefined sequences or combinations of symbols trigger a bonusing event. In one embodiment, the DPC 10 is a bingo card and the symbol is a star specific in a certain location as determined by the Bonus Server 510 while the value of that location is determined by the bingo Game Server 506. If the player hits a bingo and the winning pattern includes the location with the symbol, then a bonus event is triggered. If the last ball called is the location with the symbol, then a different bonus event is triggered.

In one embodiment, a bonusing event is triggered randomly on the Bonus Server 510. In another embodiment, the bonusing event is triggered randomly on one or more DPC 10 through its 212. In another embodiment, the bonus event is triggered randomly through a collectively random process on one or more DPCs 10 through each DPCs 10 RNG 212. In yet another embodiment, the bonusing event is triggered randomly by some other system. In an alternative embodiment, a bonusing event is triggered randomly through a plurality of the aforementioned methods. In another embodiment, a bonusing event is triggered by a plurality of game events, random events, and/or events generated on another system.

Once a bonus event has been triggered, the player or players receiving or participating in the bonus are selected at 1006 (FIG. 10). In one embodiment, a bonusing event occurs on one or more DPCs 10 associated to a single player (i.e. the player's hand), and that player is bonused. In another embodiment, a single player is selected through some other process or attribute. There is substantial prior art on player selection to receive or participation in a bonus and is hereby incorporated by reference.

In another embodiment, more than one player is selected to receive or participate in the bonus. In one embodiment, a group of players selected to receive or participate in the bonus that have one or more attributes common to or derived from an initially selected player. Non-limiting examples such a common attribute include being associated with a certain location, such as a table or gaming area, player loyalty group such as tier level, race, age, address or any other type of demographic attribute, theoretical or actual value, some element of play history such as skill level, hands played, and decision time, being associated to a dealer or group of dealers. In another embodiment, a group of players are selected independently from each other to receive or participate in the bonus. In yet another embodiment, a group of players are selected independently from each other to receive or participate in the bonus and subsequent groups of players are selected that have one or more attributes common to or derived from an initially selected players. This invention allows for awarding a bonus based on a plurality of such attributes. In an alternative embodiment, the player or players being bonuses are selected through a random process.

In one embodiment, the Bonus Server 510 selects the player or players at 1006 to participate in or receive the bonus. In another embodiment, one or more DPCs 10 associated with a player determine at 1006, either collectively or independently, whether that player participates in or receives a bonus. In an alternative embodiment, a lead DPC 10 receives relevant information from the other DPCs 10 and makes the determination at 1006. In yet another embodiment, another system, such as the Player Tracking Server 508, defines at 1006 which player or players participate in or receive the bonus. In one non-limiting example, all carded or otherwise identified players receive a bonus award, including those playing at tables using with DPCs 10, those playing at tables using only traditional playing cards, those playing on completely automated display tables (e.g. similar to the automated Poker product provided by PokerTek), those carded into slot machines on the floor, those playing in completely separate locations, and/or any combination thereof. In an alternative embodiment, a plurality of the aforementioned methods is employed to collaboratively make the determination at 1006.

In one embodiment, the bonus is the same for all players selected to receive or participate in the bonus. In another embodiment, the bonus is different based on either a random variable (location) or some other bonus defining attribute. Non-limiting examples of possible attributes include: game events (see examples provided above), game state (such as specific face values in player's hand), and player attributes (see examples provide above).

After a bonus event is recognized at 1002, the bonus determined at 1004 (either a bonus game or award, possibly on a per-player or per-group-of-players basis), the receivers or participants selected at 1006, then the bonus is initiated, executed, run, awarded, or otherwise commenced at 1008. In one embodiment, the bonus is an award or game that is not played or communicated on the DPC 10, in which case it is commenced at 1008 by the Bonus Server 510, Game Server 506, Player Tracking Server 508, or some other system.

In one embodiment, the bonus is initiated by the Bonus Server 510, Game Server 506, Player Tracking Server 508, or some other system and communicated to one or more DPCs 10. In another embodiment, the bonus is communicated to the lead DPC 10 only which communicates the bonus to the other DPCs 10. In one embodiment, one or more of the DPCs 10 display a celebratory message that the bonus was award or that the player is participating in the bonus, but the actual bonus is not executed, run, awarded or otherwise interacted with by the player on any DPC 10.

In one embodiment, the bonus is an additional game or next round of an existing game that requires interaction by the player through one or more DPCs 10. In a non-limiting example, the player may have to indicate selections or perform actions by touch or moving the DPC 10. Non-limiting examples of touching are touching to selecting a prize, or touching to uncover a hidden award. One non-limiting example of a bonus which would require moving the DPC 10 is a virtual game of trying to navigate of ball through a maze by physically moving the maze to control the direction of the ball through gravity. In this bonus round, the DPC 10 uses one or more of its internal miniaturized gyroscope, or accelerometer, or possibly tiny cameras to determine its orientation and simulate the affect of such movement on a graphical representation of a ball in a virtual maze.

Referring to, the second example shows two DPCs 600, 602 displaying a celebratory message 606 spanning both cards. In another embodiment, one or more of the DPCs 10 execute, run, or otherwise commence the bonus on their displays, but other DPCs 10 either simply provide an informational or celebratory message or display nothing at all related to the bonus. Referring to FIG. 8, example F depicts a player hand 818 consisting of three 7's which has initiated a Triple 7 Bonus. In this non-limiting example, the Bonus Server 510 has instructed two of the DPCs 10 to display celebratory graphic 820a while on the Bonus Server 510 has instructed the third DPC to run a bonus game where the player selects buttons or icons 822 to reveal is additional award.

### Communication with other Back End Servers and Services

In one embodiment, the DPC 10 communicates to a Web Server 512. The main processor 200 executes a browser client and executes the web pages and applets coming from the Web Server 512. In another embodiment, the DPC 10 communicates to a plurality of Web Servers 512. In one embodiment, a web page is served up and links to multiple web sites (e.g. mash up). In one preferred embodiment, the Web Servers 512 are behind a firewall and are on a private virtual network. In another embodiment, the Web Servers 512 are publicly accessible web sites on the Internet. In an alternative embodiment, the some Web Servers 512 are secured behind a firewall while others are not. Non-limiting examples of web protocols implemented on the DPC 10 include, but are not limited to: the following protocols or combination of protocols: tcp, upd, http, ftp, rtp, rtsp, rtcp, web service and remote procedure protocols, any flavor of XML-based protocols, and any of the secured versions or other variants of the said protocols. In an alternative embodiment, the DPC 10 communicates to some of all of the Web Servers 512 through one or more DPC Managers 504.

In one embodiment, the DPC 10 is an ultrathin client for the Web Server 512 as content is directly streamed to the DPC 10. In an alternative embodiment, the DPC 10 is a thin client, in that is receives display commands and data, and contains some user interface logic, but all business, game, and other application control and decision logic resides on the Web Server 512 and is communicated to the DPC 10. In yet another embodiment, the DPC 10 is a modified web browser, and is capable of retaining application and/or game logic as well as receiving content and other application commands from the Web Server 512. In an alternative embodiment, the Web Server 512 is simply an Application Server in that it does not use traditional web protocols or technologies, but rather uses traditional communication protocols and technologies.

In one embodiment, the DPC 10 communicates to a Media Content Management Server 514. The Content Management Server 514 manages and coordinates marketing content displayed on a DPC 10 as it does with content displayed on other digital signage devices. In another embodiment, the DPC 10 communicates to an Advertizing Server 516. In one embodiment, the content is delivered in files which are downloaded to the DPC. In an alternative embodiment, the content is delivered through live streaming.

In one embodiment, the DPC 10, DPC Manager 504, Player Tracking Server 508 or other system communicates the associated player of a DPC 10 to the Media Content Server 514 and/or Advertizing Server 516 which then selected a marketing message or advertisement tailored to the player and provided to the DPC 10 to display on either its back display 14 and/or its front display 12. In another embodiment, the DPC 10 communicates one or more nearby players to the Media Content Server 514 and/or Advertizing Server 516 which select(s) a marketing message or advertisement tailored to or specifically selected for one or more of the nearby players to be displayed on the DPC 10 in hopes that the nearby player will see it.

In one embodiment, when the DPC 10 displays the marketing or advertizing content, it confirms the play with the Media Content Server 514 and/or Advertizing Server 516 so that they can maintain proof of play logs.

In another embodiment, the Media Content Server 514 synchronizes or otherwise coordinates content being displayed on a plurality of visual displays, including but not limited to one or more DPCs 10. In another embodiment, the Media Content Server 514 synchronizes or otherwise coordinates content displayed on a plurality of visual displays with other media, such as audio devices. In one non-limiting example, the Media Content Server 514 plays a video on one or more DPCs 10 on a casino floor and the audio attributable with that video is played through surrounding speakers, possibly overhead or near to a player, such as in the table in front of him, or in his seat.

In another embodiment, the marketing or advertizing content is selected based on the face value of the DPC 10. Referring back to FIG. 8, Example E depicts one non-limiting example where a certain face value is being sponsored. The DPC 824 has a face value of the Ace of Diamonds. The DPC 10 is displaying an ad 826 for Jared's Diamonds. Other non-limiting examples of marketing content include local amenities, services, and games. One skilled in the arts will understand the capabilities of a Media Content Server 514 and Advertizing Server 516.

In one embodiment, the DPC 10 is capable of collecting biometric information on the person's touch on the DPC 10 and communicates that data to a Biometric Server 518. In one embodiment, the touch screen 16a and/or 16b are touch scanners capable of detecting or reading a fingerprint. In another embodiment, the DPC 10 has one or more miniaturized cameras capable of scanning the holders face. In both embodiments, the biometric data is communicated to the Biometric Server 518 for either identification or authentication. In one embodiment, the player identification or authentication confirmation is communicated to the DPC 10 directly. In another, the player information is communicated to another system, such as the DPC Manager 504, Game Server 506, or Player Tracking Server 508. In another embodiment, a player session is created through one of the aforementioned methods. In another embodiment, a player other than the player associated to the DPC 10 is identified as holding the DPC 10 and appropriate measures are taken. In one non-limiting example, the DPC 10 is disabled through one of the aforementioned methods.

In one embodiment, the DPC 10 communicates to a Table Management/Accounting Server 520. In one embodiment, the Table Management/Accounting Server 520 maintains the location assignment of the DPC 10, the player assignment of the DPC 10, the current face value and face value history of the DPC 10, deck assignments, play history, and/or wagers and wager history.

In another embodiment, the DPC Manager 504, the Game Server, 506, the Player Tracking Server 508, the Bonus Server 510, the Web Server 512, the Media Content Server 514, the Biometric Server 518, the Table Management/Accounting Server 520, and/or the Ad Server 516 provide raw or aggregated data to a reporting and analytics engine (not shown), such as a Business Intelligence system. The data transfer may be live data feed or batched timed feeds.

The foregoing description, for purposes of explanation, uses specific nomenclature and formula to provide a thorough understanding of the invention. It should be apparent to those of skill in the art that the specific details are not required in order to practice the invention. The embodiments have been chosen and described to best explain the principles of the invention and its practical application, thereby enabling others of skill in the art to utilize the invention, and various embodiments with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

What is claimed is:

1. A playing card to display playing card content comprising:
a first flexible electronic display to display a card face having a selected suit and value of a playing card;
a second flexible electronic display defining a card back display;
a processor unit to control said first and second displays;
a power source to power said displays and processor unit, said processor unit and power source sandwiched between said first and second displays to define said playing card and said processor unit configured to control said first display to display said card face selected suit and value and said second display to display content at said back side unrelated to either the suit or value of the first display; and
said processor unit configured for disabling at least one of said displays in response to at least one of a predetermined orientation of the playing card and when the card is not in play.

2. The playing card of claim 1 comprising said processor unit configured for disabling both displays when the card is not in use.

3. The playing card of claim 1 comprising apparatus in communication with said processor unit and configured for determining the location of the card in a storage area, said processor configured to disable said displays when said card is determined to be in said storage area.

4. The playing card of claim 1 comprising apparatus in communication with said processor unit for determining the orientation of the card resting card face down on a playing surface, said unit processor configured to disable the card face first display.

5. The playing card of claim 4 comprising said processor unit is configured to enable the card face first display when said apparatus determines that said card face has been turned over.

6. The playing card of claim 1 comprising a touch input interface at said second display configured to issue touch signals to said processor unit and said processor unit configured to receive touch input signals and control said second display to display at least a portion of the said card face of the first display;
whereby when said playing card is positioned with the first display down on a surface a touch input at said second display will display at least a portion of the said card face of the first display without turning the playing card over.

7. The playing card of claim 1 comprising said processor unit includes a memory device, a video controller to control the content at said display and a wireless receiver.

8. The playing card of claim 1 comprising said apparatus includes one or more of an orientation detector, motion detector or location detector.

9. The playing card of claim 1 comprising a playing and said processor is configured to display at said display content representing a suit and value of a playing card.

10. The playing card of claim 1 comprising said card is a trading card and said processor unit is configured to control the display to display content corresponding to a trading card.

11. The playing card of claim 1 comprising said card is a playing card and said first electronic display is configured to display content at said card face representing a card value and suit and said second display is configured to display content at said back side unrelated to either the suit or value of the first display.

12. The playing card of claim 11 comprising means for randomly assigning said suit and value to said card face first display.

13. The playing card of claim 1 where said playing card is used in a game between a plurality of players, said playing card comprising a touch input interface at said second display configured to control said processor unit to detect, when said playing card is resting on a playing surface card face down, a player covering a sufficient portion of said second display to permit revelation of at least a portion of said card face at said second display without revealing the card face to other players.

14. A playing card to display playing card content comprising:
a first flexible electronic display to display a card face having a selected suit and value of a playing card;
a second flexible electronic display defining a card back display;
a processor unit to control said first and second displays;
a power source to power said displays and processor unit, said processor unit and power source sandwiched between said first and second displays to define said playing card and said processor unit configured to control said first display to display said card face selected suit and value and said second display to display content at said back side unrelated to either the suit or value of the first display;
apparatus in communication with said processor unit for determining the orientation of the card resting card face down on a playing surface, said unit processor configured to disable the card face first display.
